(19) United States
(12) Patent Application Publication
(10) Pub. No.: US 2010/0177519 A1
(43) Pub. Date: Jul. 15, 2010

(54) ELECTRO-HYDRODYNAMIC GAS FLOW LED COOLING SYSTEM

(76) Inventor: Daniel J. SCHLITZ, Lilburn, GA (US)

Correspondence Address: PILLSBURY WINTHROP SHAW PITTMAN LLP, P.O. BOX 10500, MCLEAN, VA, 22102, US

(21) Appl. No.: 12/416,013

(22) Filed: Mar. 31, 2009

Related U.S. Application Data
(63) Continuation-in-part of application No. 11/338,617, filed on Jan. 23, 2006, now Pat. No. 7,661,468.

(51) Int. Cl. F21V 29/00; H02K 44/00

(52) U.S. Cl. 362/294; 417/48

(57) ABSTRACT

The present invention relates to cooling systems, and in particular to cooling systems providing forced convective gaseous flow for dissipating heat off of light-emitting diodes (LED). According to one aspect, a cooling system employs a heat sink in combination with an EHD pumping mechanism such as corona wind or micro-scale corona wind or by a temporally controlled ion-generation technique. For LEDs a channel-array structure can be employed to embody the heat sink. The EHD pumps are located at the inlet or outlet of the heat sink channels. Many advantages are achieved by the cooling system of the invention, including that the entire system can have similar or better performance than a conventional heat sink and fan system but with one-tenth the volume and weight and can operate silently. The present invention also relates to a method of fabricating a micro-channel heat sink employing EHD gas flow for use in LED cooling.

### CROSS-REFERENCE TO RELATED APPLICATIONS

The present application is a continuation-in-part of U.S. patent application Ser. No. 11/338,617, the contents of which are incorporated herein by reference in their entirety.

### FIELD OF THE INVENTION

The present invention relates to cooling systems, and more particularly to cooling systems for high-power light emitting diodes (LED) employing forced-convection gas flow through heat sinks.

### BACKGROUND

A Light Emitting Diode (LED) is a semiconductor device which converts electric energy into light, LEDs can be used, for example, as optical indicators, or for lighting. LED lighting has been around since the 1960s, but is just now beginning to appear in the residential market for space lighting. At first white LEDs were only possible by “rainbow” groups of three LEDs—red, green, and blue—by controlling the current to each to yield an overall white light. This changed in 1993 when a blue indium gallium chip with a phosphor coating was created that can be used to create the wave shift necessary to emit white light from a single diode. This process can be much less expensive for the amount of light generated.

Typically, currently available diodes are about ¼ inch in diameter and use about ten milliamps to operate at about a tenth of a watt. LEDs are small in size, but can be grouped together for higher intensity applications. Thereby, they can be assembled to form a graphical display. Typical LED fixtures require a driver which is analogous to the ballast in fluorescent fixtures. The drivers can be built into the fixture (like fluorescent ballasts) or they are a plug transformer for portable (plug-in) fixtures. The plug-in transformers allow the fixture to run on standard 120 (or 220) volt alternating current (AC), with a modest (about 15 to 20 percent) power loss.

The efficacy of a typical residential application LED is approximately 20 lumens per watt (LPW), though efficacies of up to 100 LPW have been created in laboratory settings. In comparison, incandescent bulbs have an efficacy of about 15 LPW and ENERGY STAR qualified compact fluorescents are about 60 LPW, depending on the wattage and lamp type. Some manufacturers claim efficacies much higher than 20 LPW.

LEDs can be better at placing light in a single direction than incandescent or fluorescent bulbs. Because of their directional output, they have unique design features that can be exploited by clever designs. LED strip lights can be installed under counters, in hallways, and in staircases; concentrated arrays can be used for room lighting. Waterproof, outdoor fixtures are also available.

Typically, LED lights are more rugged and damage-resistant than compact fluorescents and incandescent bulbs. LED lights don't flicker. LEDs can last considerably longer than incandescent or fluorescent lighting. LEDs don't typically burn out like traditional lighting, but rather gradually decrease in light output. Their “useful life” is defined by the Alliance for Solid-State Illumination Systems and Technologies (ASSIST) as the time it takes until 70% of initial light output is reached and often exceeds 50,000 hours. LEDs are resistant to thermal and vibrational shocks and perform well when subjected to frequent on-off cycling. Therefore, LEDs are often used when reliability matters, for example in communication when laser LEDs are used to send signals via fiber glass cable. The longer life cycle also has economical and ecological benefits in lighting. Common uses of LEDs for lighting include: Task and reading lamps; Linear strip lighting (under kitchen cabinets); Recessed lighting/ceiling cans; Porch/outdoor/landscaping lighting; Art lighting; Night lights; Stair and walkway lighting; Pendants and overhead; and Retrofit bulbs for lamps.

However, as will be greatly discussed in this invention, LEDs are very heat sensitive. Excessive heat or inappropriate applications can dramatically reduce both light output and lifetime.

An LED, like other electrical devices, does not have perfect light-emission efficiency in converting electrical energy to light energy. Accordingly, some of the supplied electrical power is converted into heat. This heat increases the operating temperature of the LED so as to degrade the operating characteristics of the LED.

The operating temperature of the LED is inversely proportional to the energy band gap, and the energy band gap is inversely proportional to the wavelength of light emitted from the LED. Accordingly, as the operating temperature of the LED increases, the energy band gap becomes narrower, and thus the wavelength of the emitted light increases. Therefore, when an LED emitting blue light has an increase in its operating temperature, it may emit green light, rather than blue light. This phenomenon is called “a color shift”. Consequently, when the heat generated by the LED is not rapidly dissipated to the outside, a desired-color light cannot be obtained due to color shift by the LED. Further, the brightness efficiency of light emitted from an LED decreases as the operating temperature of the LED increases.

In a light-emitting package, heat that is generated from the LEDs can be transferred by heat sink such that the heat can then be dissipated to the outside. However, there is a limitation as to how much heat can be rapidly transferred from the light-emitting units to the heat sink. Thus, there is a limited amount of power that can be provided to the LEDs before the operating characteristics of the LEDs degrade. Also, there is a limit to how much the overall thickness of the light-emitting package can be reduced because there is a minimum thickness of the heat sink in the light-emitting unit plus a minimum thickness of, for example, a printed circuit board to which the LED is mounted.

Generally, a LED package may include a LED chip, a lead frame through which electric current is applied to the LED chip, and a housing for supporting the lead frame. In recent years, attention to LED package-based lighting applications has rapidly increased. To apply the LED package to lightings improved luminescence and a high optical output of 1,000's of lumens or more are sought. Since output luminescence is proportional to the amount of input current, a desired optical output can be obtained by supplying a high electric current to the LED chip. However, this increase in input current may generate excessive heat.

Further, if the heat is not dissipated from the LED package, the heat may cause dislocations and mismatches in a semiconductor crystal of the LED chip, thereby reducing the life-time of the LED. Hence, a heat sink for cooling is typically provided to the LED package as a heat absorption or dissipation source.

The LED package may include a plurality of LED chips mounted on a heat sink formed of a single heat dissipation slug to emit light of different wavelengths such that the LED chips can be individually operated to emit multiple colors. For example, a red LED chip, a green LED chip, and a blue LED chip can be mounted together in a single LED package to emit plural colors by operating the LED chips in an individual manner or in combination. An example of this is given in FIG. 25.

However, if the LED chips for emitting red, green and blue colors are mounted together in the single LED package, all of the LED chips are operated to emit white light Accordingly, it is difficult for the LED package to adjust the balance between colors. Since a LED for emitting white light may include phosphorus, there are many difficulties in mounting the white LED chip and other LED chips for emitting different colors in a single LED package. To achieve individual operation of the LED chips on a single heat dissipation slug (made from a heat-conducting metal), the LED chips can be lateral-type LED chips that are electrically insulated from the heat dissipation slug, and each LED chip can be electrically wired by a two-bonding method in which the LED chip is connected to two lead-frames via two bonding wires.

For several decades the preferred light emitting diode construction was the so-called T13/4 epoxy package. This inexpensive package is more than adequate at relatively low LED power levels. As LED performance levels rose, and the power dissipated within these devices reached a critical level, the self-generated heat within the LED die itself became an important design issue. The well-known behavior of many LED families to substantially dim and degrade at higher operating temperatures drove the need for better thermal management solutions.

Larger LED dies and more efficient, low thermal resistance leads or lead frames filled much of the need for higher performance devices. However, as luminous output increased by substantially increasing device drive current, self-generated heat again becomes a design issue.

Various dual in-line LED packages provided decent luminous flux at nominal cost for all but the most demanding applications. Unfortunately, it is these more demanding applications that offer the greatest market potential. Outdoor lighting of various kinds, such as automotive exterior lamps, traffic signals, railroad signals, and even advertising signs, are exposed to high ambient operating temperatures. When coupled with the self-generated heat of the LED itself, the resulting die (junction) temperature may quickly degrade the LED, shortening its life and reducing its light output. For some safety-critical applications such a reduction in luminous output can have dire consequences.

In order to ameliorate these thermally driven problems, LED manufacturers began to manufacture more, thermally capable devices. One such device is designed only for mechanical crimp attachment, as the relatively low thermal resistance of its lead frame may damage the LED die if the device is soldered. Another path to high performance LEDs with aggressive thermal management is exemplified by products which have essentially separated the major heat flow path out of the die from the electrical leads that power the devices One assembly employs an elegant yet costly bulk diamond insulator to de-couple the die electrically from the integral heat sink post. This plated copper element transfers heat from the die to an external heat dissipater. The use of a bulk (or thin film) diamond insulator is advantageous because of diamond's very high thermal conduction, which is greater than that of copper (400 W/m/° K). Unfortunately, the excellent thermal performance comes at a high price, and such LEDs are typically priced at least an order of magnitude above less sophisticated but nearly comparable ‘non diamond’ LEDs. Another assembly modifies the existing commercial dual-in-line package to accommodate an integral heat sink but wherein an electrically non-conductive material must be placed between the diode and the heat sink to make sure no electrical current passes from the diode to the heat sink, e.g., U.S. Pat. No. 5,857,767. While the thermal impedance of this LED is nominally 3.7 times higher than the design with diamond insulation, cost/performance criteria favor this design.

In a particular application of LEDs, they can be used as a source of infrared light. Infrared light has been widely used in modern society, such as the sensing system of an automatic door and the light source of a surveillance camera. To use as a light source, multiple LEDs are combined to provide a practical light intensity. This requires a significant amount of space and increases the production cost. Further, the clustering of LEDs, in general, results in additional heat radiation problem, which in turn may cause overheating and may result in damage of the LEDs and blurring of the transparent enclosure. Basically, a light source using a closely packed cluster of LEDs would have problems in durability and light intensity, both increasing the cost of using such light sources unless properly cooled.

If not properly cooled, LEDs can suffer damage. For example, the following failures may happen to LEDs if not cooled properly: Nucleation and growth of dislocations is a known mechanism for degradation of the active region of a LED, where the radiative recombination occurs. This requires a presence of an existing defect in the crystal and is accelerated by heat, high current density, and emitted light. Gallium arsenide and aluminum gallium arsenide are more susceptible to this mechanism than gallium arsenide phosphide and indium phosphide. Due to different properties of the active regions, gallium nitride and indium gallium nitride are virtually insensitive to this kind of defect. Electromigration caused by high current density can move atoms out of the active regions, leading to emergence of dislocations and point defects, acting as non-radiative recombination centers and producing heat instead of light. Metal diffusion caused by high electrical currents or voltages at elevated temperatures can move metal atoms from the electrodes into the active region. Some materials, notably indium tin oxide and silver, are subject to electromigration which causes leakage current and non radiative recombination along the chip edges. In some cases, especially with GaN/InGaN diodes, a barrier metal layer is used to hinder the electromigration effects. Ionizing radiation can lead to the creation of defects as well, which leads to issues with radiation hardening of circuits containing LEDs (e.g., in optoisolators). Differentiated phosphor degeneration—the different phosphors used in white LEDs tend to degrade with heat and age, but at different rates causing changes in the produced light color, for example, purple and pink LEDs often use an organic phosphor formulation which may degrade after just a few hours of operation causing a major shift in output color. Short circuits, mechanical stresses, high currents, and corrosive environment can lead to formation of whiskers, causing short circuits. Thermal runaway non-homogeneities in the substrate, causing localized loss of thermal conductivity, can cause thermal runaway where heat causes damage which causes more heat etc. Most common ones are voids caused by incomplete soldering, or by electromigration effects and Kirkendall voiding. Current crowding, non-homogeneous distribution of the current density over the junction. This may lead to creation of localized hot spots, which poses risk of thermal runaway. Epoxy degradation: Some materials of the plastic package tend to yellow when subjected to heat, causing partial absorption (and therefore loss of efficiency) of the affected wavelengths. Thermal stress. Sudden failures are most often caused by thermal stresses. When the epoxy resin package reaches its glass transition temperature, it starts rapidly expanding, causing mechanical stresses on the semiconductor and the bonded contact, weakening it or even tearing it off. Conversely, very low temperatures can cause cracking of the packaging. Electrostatic discharge (ESD) may cause immediate failure of the semiconductor junction, a permanent shift of its parameters, or latent damage causing increased rate of degradation. LEDs and lasers grown on sapphire substrate are more susceptible to ESD damage. Reverse bias—although the LED is based on a diode junction and is nominally a rectifier, the reverse-breakdown mode for some types can occur at very low voltages and essentially any excess reverse bias causes immediate degradation, and may lead to vastly accelerated failure. 5V is a typical, “maximum reverse bias voltage” figure for ordinary LEDs, some special types may have lower limits.

As we will show in the following analysis of the solutions known in the art, passive cooling is either not sufficient, or not cost-efficient. With the expected advancements of LED technology none of the solutions known in the art can effectively or efficiently (that includes cost) deal with the following problems:

High heat density where heat is generated very locally over an area of very few square millimeters.

High absolute temperature where the junction temperature must not exceed 120 degrees C. (sometimes more).

Quick temperature rise over time where the junction temperature because of the high currents can rise above specification within a few seconds.

One of the challenges in cooling high-power LEDs or other LEDs used for lighting purposes is to remove the increased amount of heat away while the LED operates in typically confined spaces and/or is assembled in a compact device with a small form factor. According to a typically used rule for thermal modeling, the amount of heat removed is proportional to the area that dissipates the heat into the ambient air (typically a heat sink with a large surface) times the so-called heat coefficient. The heat coefficient depends on the material used, for example Aluminum has a thermal conductivity of 160 to 210 Watts per square meter and per degree of temperature difference, but more importantly it depends on other aspects such as so-called boundary layer effects and other flow parameters which affect the amount of heat dissipated into ambient air. Therefore, the fundamental laws of physics dictate that either the heat sink surface must significantly be increased or the heat coefficient must be significantly improved to cope with the increased amount of heat generated by modern LEDs.

Today, increasing the heat dissipating surface has reached practical limits for most use-cases because of the size and foot-print restrictions of typical LED assemblies. One of the important advantages of LEDs is their compact dimensions which will get lost once huge heat sinks are needed. Also, the cost of those heat sinks have a negative economic effect on the other-wise very cost-efficient LED. As long as only passive cooling is used, one has to revert to heat sink materials which have a higher thermal conductivity but also incur much higher costs. This is the fundamental drawback of all passive cooling techniques for LEDs such as the following:

In U.S. Pat. No. 6,480,389 entitled “Heat Dissipation Structure for Solid-State Light Emitting Device Package” a LED device uses fluidic coolant in a sealed housing for heat dissipation. In U.S. Pat. No. 6,517,218 entitled “LED Integrated Heat Sink” a LED is built in electrical connectivity with a heat sink for passive, convection-based heat dissipation. In U.S. Pat. No. 7,165,866 entitled “Light Enhanced and Heat Dissipating Bulb” a LED device sits in a bulb-like seat where the seat has one or more heat sinks for passively cooling the LED. In U.S. Pat. No. 7,192,163 entitled “Light-Emitting Unit with Enhanced Thermal Dissipation and Method for Fabricating the Same” a printed circuit board which mounts the LED is used to passively transport heat away from the LED. In U.S. Pat. No. 7,282,841 entitled “Lamp Assembly with LED Light Sources Including Threaded Heat Conduction Base” a LED which is used for illuminating camera surveillance is passively cooled using a heat conducting meta body. In U.S. Pat. No. 7,420,811 entitled “Heat Sink Structure for Light-Emitting Diode Based Streetlamp” a lamp house with heat fins is used for passively cooling LEDs. In U.S. Pat. No. 7,465,069 entitled “High-Power LED Package Structure” an LED is passively cooled with a tri-structure of a heat sink and a heat base. In U.S. Patent Publ. No. 2002/0050779 entitled “Light Emitting Diode with Improved Heat Dissipation” a LED is mounted on a heat conducting metal frame to passively transport heat away from the LED. In U.S. Patent Publ. No. 2005/0045904 entitled “Light Emitting Diode with High Heat Dissipation” a via in a printed circuit board is used as a heat pipe to transport heat passively away from a LED. In U.S. Patent Publ. No. 2006/0092640 entitled “Light Enhanced and Heat Dissipating Bulb” heat is removed using passive cooling. In U.S. Patent Publ. No. 2006/0102922 entitled “LED Heat Dissipation Support” a LED chip carrier which supports the LED device passively transports the heat away from the LED. In U.S. Patent Publ. No. 2006/0261359 entitled “Heat Sink for Light Emitting Diode Bulb” a LED is mounted to heat conducting lamp house to passively transport heat away from the LED. In U.S. Patent Publ. No. 2007/0081341 entitled “LED Assembly With Vented Circuit Board” many LEDs are assembled to form an array which is then mounted and passively cooled via a vented printed circuit board using a thermal cooling layer. In U.S. Patent Publ. No. 2008/0180014 entitled “LED Heat Sink” a through hole in a printed circuit board is used for a heat sink to passively transport the heat away from a mounted LED. In U.S. Patent Publ. No. 2008/0180015 entitled “Heat-Sink Module of Light-Emitting Diode” a LED is directly mounted on a big heat block for passively moving heat away from the LED. In U.S. Patent Publ. No. 2008/0205061 entitled “Apparatus and Method of Using a LED Light Source to Generate an Efficient, Narrow, High-Aspect Ration Light Pattern” a complex optical lens structure with means for passive cooling of LEDs is used to focus light from many LEDs. In U.S. Patent Publ. No. 2008/0253125 entitled “High-Power LED Lighting Assembly Incorporated with a Heat Dissipation Module with Heat Pipe” a LED is passively cooled using a combination of a heat sink and a heat pipe. In U.S. Patent Publ. No. 2009/0001393 entitled “Multi-Light Emitting Diode Package” a multi-LED package is passively cooled by mounting LEDs on a combination of heat sinks and heat slugs. In U.S. Patent Publ. No. 2009/0040759 entitled “LED Lamp with a Heat Sink Assembly” LEDs are passively cooled by a combination of one inner and one outer toroidal heat sink. In U.S. Patent Publ. No. 2009/0040760 entitled “Illumination Device Having Unidirectional Heat Dissipating Route” LEDs are passively cooled using a unidirectional heat pipe and heat sink. In U.S. Patent Publ. No. 2009/0040776 entitled “LED Lamp with a Heat Dissipation Device” LEDs are passively cooled using heat sinks.

To overcome the problems of passive cooling, certain approaches have been described which teach how to use fans or blowers for increasing the heat coefficient. For example, in U.S. Patent Publ. No. 2007/0076422 entitled “Lighting And/Or Signaling Device for a Motor Vehicle Incorporating a Material Having Thermal Anisotropy” a power LED gets cooled by a heat sink and a rotating fan combination using moving parts. Or, in another example, in U.S. Patent Publ. No. 2008/0023720 entitled “Light Emitting Diode Having Module with Improved Heat Dissipation Structure” a LED is cooled using a heat pipe, heat sink and a rotating fan.

Besides the obvious drawback that any rotating fan and/or blower requires a large form-factor device to generate a sufficient airflow—which in most practical cases is much too large to build a compact lighting device—rotating fans and/or blowers are inherently unreliable because of the wear and tear of their moving parts suffering from mechanical friction and, therefore, mechanical break-down. Thus, mechanical solutions for active cooling do not apply well to LED cooling in general. Overall the expected lifetime and/or Mean Time Between Failure of rotating fans and/or blowers can be significantly shorter and does not comply with the very long lifetime of LEDs.

Two publications “Investigation of LED Heat Transfer Enhancement by EHD Technology” from C. T. Huang, published as a Thesis at National Tsing Hua University, July 2005 [Huang-2005] and “Study on the Cooling Enhancement of LED Heat Sources via an Electrohydrodynamic Approach” from S. W. Chau et al. Published at the 33^{rd} Annual Conference of the IEEE IECON, November 2007 [Chau-2007] describe a concept for using EHD techniques for actively cooling LED. Both, [Huang-2005] and [Chau-2007], describe experimental setups where an EHD pump generates a corona wind to provide an airflow impinging a LED heat sink for cooling. The airflow is directly controlled via the input voltage and can improve cooling up to three times compared with passive cooling. However, both publications, [Huang-2005] and [Chau-2007], fail to teach important aspects needed to apply EHD techniques to practical LED cooling.

First, the required voltages to engage the corona wind are very high—15 kV to 23 kV in [Chau-2007] and 30 kV in [Huang-2005]—which is impractical, for example, for safe operation. Second, the form factor of both EHD pumps is much too large, for example, the gap between the two corona electrodes is 30 millimeters in [Chau-2007] and between 10 millimeters and 40 millimeters in [Huang-2005]. Compared with the size of typical LED device of approximately 5 millimeters, these dimensions are much too large to build a compact cooling device that suits real-life LED applications. Third, no techniques for dealing with dust or avoiding sparks, arcs, or ozone—all those can lead to potentially dangerous situations—are provided. Fourth, neither approach can be manufactured cost efficiently to provide an economic LED lighting solution. And, at last, neither [Huang-2005] nor [Chau-2007] will result in a safe and reliable LED cooling system: For example, [Huang-2005] mentions that the corona wires may vibrate during operation causing the cooling system to fail either because of arcs causing electrical shorts or because the corona electrodes may get destroyed by the vibration forces and/or shocks.

For the cooling of high-power LEDs, heat skis are a common device used to prevent overheating. Heat sinks rely mainly on the dissipation of heat from the device using air. However, dissipating heat using a gas, such as air, is difficult because of the poor thermal properties of gases. Gases have low thermal conductivities, which inhibits heat absorption. They also have low heat capacity, which causes them to heat up quickly after absorbing only a small amount of heat. This retards the rate and the amount of heat absorption by decreasing the temperature difference between the gas and the heat sin

Conventional heat sinks have a limited amount of surface area that can be put into a given volume. As a result, these heat sinks are large, especially in the direction perpendicular to the heat source and substrate. Additionally, these heat sink designs do not integrate well with certain types of fluid pump designs.

A novel heat sink described in U.S. patent application Ser. No. 11/181,106, filed Jul. 13, 2005, and entitled “Micro-Channel Heat Sink,” the contents of which are incorporated by reference herein, dramatically advances the state of the art of heat sinks. It describes a structure comprised of a large array of relatively short micro-channels that allows heat to be more readily transported through short, low thermal resistant paths. As a result, heat sinks based on this concept have a fraction of the volume of traditional heat sinks while maintaining high performance cooling.

The heat sink described in U.S. patent application Ser. No. 11/181,106 and other more conventional heat sink designs typically rely on fans and blowers to promote flow of gases through their structures. Meanwhile, other techniques have been developed that directly convert electricity into fluid flow. These methods are collectively referred to as electro-hydrodynamic (EHD) pumps. One of these methods of pumping a gas is called corona wind. It refers to the gas flow that is established between two electrodes, one sharp and the other blunt, when a high voltage is applied between the electrodes. The gas is partially ionized in the region of high electric field near the sharp electrode. The ions that are attracted to the more distant, blunt electrode collide with neutral molecules en route and create a pumping action.

Another type of EHD pump is described in U.S. Pat. No. 7,214,949, entitled “Ion Generation by the Temporal Control of Gaseous Dielectric Breakdown,” the contents of which are incorporated herein by reference. In this method, ions are generated by a temporally controlled breakdown of the gas and are then attracted to oppositely charged electrodes to create a pumping action.

U.S. Patent Publication No. 2005/0007726 A1, entitled “Ion-Driven Air Flow Device and Method,” relates to an ion-driven, fluid flow generating microscale pump device and method for creating a flow of gaseous fluid for the purpose of cooling solid objects. The ion generation involves an electron tunneling process and the EHD pumping uses a traveling electric field concept. The concepts of this patent application are interesting but are impractical and complex in many respects.

U.S. Pat. No. 6,659,172, entitled “Electro-hydrodynamic heat exchanger” relates to a counter flow heat exchanger with EHD enhanced heat transfer. The flow is not primarily driven by an EHD pump, but rather an external device of some kind. The EHD action presumably creates secondary flows that enhance the heat transfer rate of the system and improve its performance.

U.S. Pat. No. 4,210,847, entitled “Electric wind generator” discloses a corona wind pump to provide air flow for heat transfer purposes. However, there is no mention of heat sink integration.

U.S. Pat. No. 4,380,720, entitled “Apparatus for producing a directed flow of a gaseous medium utilizing the electric wind principle” discloses a corona wind device for moving air. It includes an aerosol addition that enhances the electro-hydrodynamic coupling, i.e. it increases the efficiency of the pumping action.

U.S. Pat. No. 5,237,281 entitled “Ion drag air flow meter” and U.S. Pat. No. 4,953,407 entitled “Ion-drag flowmeter” disclose reverse corona wind devices that measure the ion current to determine the air flow velocity.

All together, there are yet no solutions known in the art for LED cooling that are effective enough to remove the high amounts of heat generated by today's high-power LEDs, have a small enough form factor required for compact lighting applications, comply with the reliability and lifetime of typical LED lighting applications, are safe to use, and can be manufactured cost-effectively.

### SUMMARY

The present invention relates to cooling systems, and in particular to cooling systems providing forced convective gaseous flow for cooling high-power LEDs. According to one aspect, a cooling system employs a heat sink in combination with an EHD pumping mechanism such as corona wind or micro-scale corona wind or by a temporally controlled ion-generation technique. A channel-array structure can be employed to embody the heat sink. The EHD pumps are located at the inlet or outlet of the heat sink channels. Many advantages are achieved by the cooling system of the invention, including that the entire system can have similar or better performance than a conventional heat sink and fan system but with one-tenth the volume and weight and can operate silently.

According to one aspect, a cooling apparatus according to the invention comprises a structure that is thermally coupled to an LED; and an electrohydronamic (EHD) pump for creating an airflow over the structure.

According to another aspect, a cooling system according to the invention includes a structure having one or more LED(s); and an electrohydronamic (EHD) pump for actively cooling the LED(s) in the structure, wherein the EHD pump is adapted to perform the active cooling without having any moving parts.

According to still further aspects, a cooling system according to the invention includes a structure having one or more LED(s); and an electrohydronamic (EHD) pump for actively cooling the LED(s) in the structure, wherein the EHD pump is adapted to have a life cycle greater than 100 k hours, and to support more than 10 k switching cycles of the LED(s).

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a perspective view of one preferred embodiment of an EHD gas flow cooling system according to the invention;

FIG. 2 is a perspective view of another preferred embodiment of a cooling system according to the invention;

FIG. 3 is a perspective view of another preferred embodiment of a cooling system according to the invention;

FIG. 4 is a perspective view of another preferred embodiment of a cooling system according to the invention;

FIG. 5 is a perspective view of another preferred embodiment of a cooling system according to the invention;

FIG. 6 is a perspective view of another preferred embodiment of a cooling system according to the invention;

FIGS. 7A to 7C are perspective views of various configurations of another preferred embodiment of a cooling system according to the invention;

FIG. 7D is a perspective view of various configurations of electrode tips that can be implemented in a cooling system according to the invention;

FIG. 8 is a perspective view of another preferred embodiment of a cooling system according to the invention;

FIG. 9 is a perspective view of another preferred embodiment of a cooling system according to the invention;

FIG. 10 is a perspective view of another preferred embodiment of a cooling system according to the invention;

FIG. 11 is a graph showing a trend of a cooling system's thermal resistance as a function of frequency of the applied voltage in a prototype constructed in accordance with the invention;

FIGS. 12A and 12B illustrate a preferred implementation of current pulsing ion generation techniques in a cooling apparatus according to the invention;

FIG. 13 is a drawing showing a preferred embodiment of the EHD gas flow cooling system mi a mobile computer application;

FIGS. 14A to 14D shows the sequence of one possible micro-fabrication process for making a micro-scale EHD cooling system according to the invention;

FIG. 15 is a schematic view showing a heat sink construction complemented by one or more EHD pumps for active cooling one or more LEDs;

FIG. 16 is a schematic view showing a heat sink construction complemented by one or more EHD pumps for active cooling of one or more LEDs with a crossflow;

FIG. 17 is schematic view showing a heat sink construction complemented by one or more EHD pumps for active cooling of one or more LEDs with an impinging airflow;

FIG. 18 is a schematic view of another heat sink construction complemented by one or more EHD pumps for active cooling of LEDs with an impinging airflow;

FIG. 19 is a schematic view of another heat sink construction complemented by one or more EHD pumps for active cooling of LEDs with crossflow;

FIG. 20 is a schematic view of yet another heat sink construction complemented by one or more EHD pumps for active cooling of LEDs with a combination of an impinging airflow and a crossflow;

FIG. 21 shows an exemplar of a LED lighting construction;

FIGS. 22A and 22b show an exploded view of a LED lighting construction enhanced by an EHD pump for active cooling;

FIG. 23 shows an exemplar of a LED lighting construction enhanced by EHD pump for active cooling;

FIG. 24 shows a multi-LED setup enhanced by one or more EHD pumps for active cooling;

FIG. 25 shows a LED panel actively cooled with an EHD pump;

FIG. 26 shows an LED panel actively cooled by multiple EHD pumps;

FIG. 27 shows a close-up view of a LED panel actively cooled with a crossflow generated by an EHD pump;

FIG. 28 shows a close-up view of a panel of multi-LEDs mounted on a vented circuit board and actively cooled with a crossflow generated by an EHD pump;

FIG. 29 shows a panel of LEDs mounted on a vented circuit board and actively cooled with an airflow generated by an EHD pump, the airflow going through the vents; and

FIG. 30 shows an example EHD pump having a toroidal shape according to aspects of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Generally, the present invention relates to cooling systems that employ forced convection gaseous flow through a heat sink structure, preferably using EHD techniques. The EHD flow is preferably generated by one of three mechanisms that will be described in detail herein; (1) corona wind, (2) micro-scale corona wind or (3) by the method described in the U.S. patent application Ser. No. 11/271,092, entitled “Ion Generation by the Temporal Control of Gaseous Dielectric Breakdown,” filed on Nov. 10, 2005, the contents of which are incorporated herein by reference. However, the EHD flow can also be generated by a combination of two or more of these three mechanisms, or by other present and future EHD mechanisms, or in combination with other conventional mechanisms such as fans, while remaining within the teachings of the present invention.

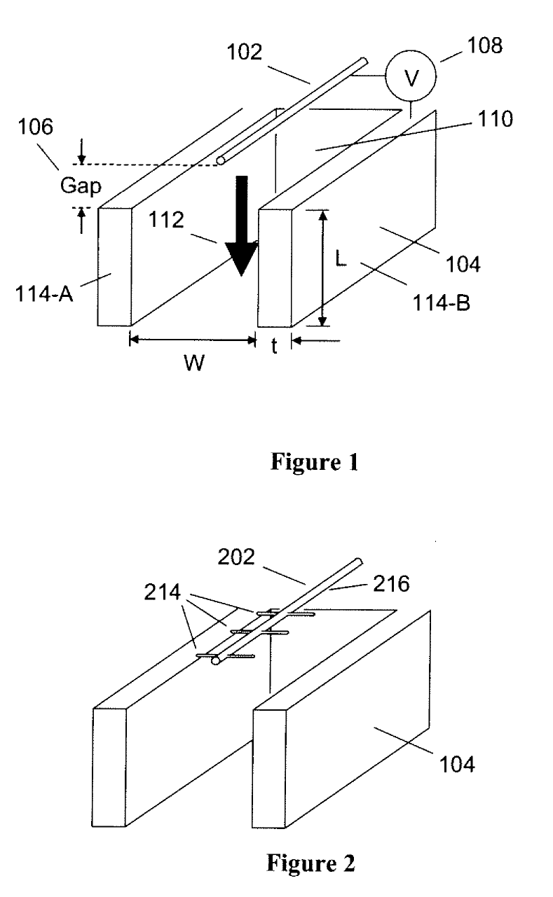

FIG. 1 illustrates an example cooling system according to the invention. As shown in FIG. 1, a first electrode 102 is separated from a second electrode 104 by a gas (e.g. air) gap 106. According to an aspect of the invention, the second electrode 104 is integrally formed in a portion of a heat sink, and the first and second electrodes are disposed near the inlet of a heat sink channel 110. A voltage source 108 is coupled to the electrodes 102, 104, and establishes an electric field across the gas gap 106 which generates ions according to one of the techniques as will be described in more detail below. The ion generation across the gap 106 imparts momentum to the gas, which causes gas to flow through the channel 110, in a direction 112 from its inlet to its outlet. The gas flow through the channel 110 facilitates removal of heat from the heat sink, and in turn acts to remove heat from a source of heat that is thermally coupled to the heat sink, as will be understood by those skilled in the art.

In one example embodiment, the heat sink material is an electrically conductive material such as aluminum, to which the voltage source 108 is directly connected via any number of connection means known to those skilled in the art, and thus acts as the second electrode 104. The first electrode 102 in some examples can be an aluminum, copper or other type of electrically conductive wire, or it can be a patterned conductor on a dielectric material, and thus is not limited to a round shape, as will become more apparent from the descriptions below.

In the illustrated example, the channel 110 is defined by a heat sink fin 114-A that is separated by another fin 114-B. The various orientations, materials, geometries and dimensions of certain of the illustrated elements can depend on the ion-generation techniques used, and will become more apparent from the descriptions below. However, it should be noted that a cooling system according to the invention can contain many channels 110, defined by fins or other heat sink structures, all or certain of which will be equipped with ion-generating electrodes for causing a gas flow therethrough. It should be further noted that similar results can be obtained by providing the electrodes near the outlet of a channel rather than the inlet as illustrated in FIG. 1, and as will be described in more detail herein.

### Corona Wind

One EHD pumping method that can be used in the cooling system of the invention, corona wind, has been studied extensively (See O. Stuetzer, “Ion Drag Pressure Generation”, J. Applied Physics, V. 30, N. 7, pp. 984-994, 1959; B. L. Owsenek, J. Seyed-Yagoobi, “Theoretical and Experimental Study of Electrohydrodynamic Heat Transfer Enhancement Through Wire-Plate Corona Discharge”, J. Heat Transfer, V. 119, pp. 604-610, 1997; H. Kalmen and E. Sher, “Enhancement of heat transfer by means of a corona wind created by a wire electrode and confined wings assembly”, Applied Thermal Eng., 21, pp. 265-282, 2001). It involves two electrodes, one sharp (e.g. first electrode 102), the other blunt (e.g. second electrode 104), spaced apart by a gap (e.g. gap 106) of many centimeters. A large, constant voltage (DC, e.g. source 108) is applied between the electrodes. This creates an intense electric field near the sharp electrode and a weaker electric field in the remainder of the region between the electrodes. Gaseous breakdown is initiated in the high electric field region near the sharp electrode (corona discharge). In this zone, free electrons obtain sufficient energy to create pairs of positive ions and additional free electrons, as they collide with neutral molecules. This action creates an avalanche effect such that a large number of ions are generated in a small volume. Ions produced in this region travel across the gap (e.g. gap 106), under the influence of the electric field, towards the blunt electrode. On the way, they collide with neutral molecules and impart momentum to the bulk gas causing the gas to flow.

### Micro-Scale Corona Wind

Another method of EHD pumping that can be used in a cooling system such as that illustrated in FIG. 1, and is itself an additional aspect of the invention, is referred to herein as micro-scale corona wind. A micro-scale corona is a novel extension of the corona wind phenomenon down through the low end of the meso-scale and into the micro-scale. A micro-scale corona is herein defined as a corona discharge between electrodes whose spacing is less than 1 cm—below the minimum gap size reported for conventional coronas.

The micro-scale corona wind, similar to the conventional corona wind, is established as a corona discharge between two electrodes—one blunt (e.g. second electrode 104), the other sharp (e.g. first electrode 102). But in a conventional corona, the ratio of the size of the gas gap (e.g. 106) to the sharp electrode characteristic dimension (effective diameter) is only required to exceed 6:1 (see Gaseous Electronics, Editors: Merle N. Hirsh & H. J. Oskam, Academic Press, New York, 1978). The present invention recognizes that, in a micro-scale corona, this minimal ratio no longer applies. With a micro-scale corona the ionization region must be confined more closely to the sharp electrode. This is accomplished by increasing the gap-to-diameter ratio. This limits the size of the region where ionization occurs and prevents a general breakdown of the gas and the formation of a destructive arc or spark, as the present invention further recognizes is advantageous.

More particularly, the present invention further recognizes that the gap-to-diameter ratio requirement increases beyond 6:1 as gap size decreases. For example, a gas gap of 1.25 mm requires that the ratio exceed 25:1, for smaller gaps the requirement can exceed 100:1. This requirement means that a typical micro-scale corona electrode must be in the range of sub-microns to approximately 10 μm in diameter, but generally less than 100 microns. Larger diameter electrodes will not exhibit a micro-scale corona regime, but will instead go directly from insulating to arcing as the voltage between the electrodes is raised. The size requirement may necessitate the use of micro-fabrication techniques (examples include photolithography, ion milling and laser induced forward transfer, etc.) for the construction of the electrodes.

The micro-scale corona wind is advantageous because the size required for a micro-scale corona is greatly reduced as compared to a conventional corona. This enables the pumping section to be reduced in size and allows individual pumps, and hence heat sink channels (e.g. channels 110), to be spaced more closely. A second advantage of the microscale corona is its low turn-on voltage. Typical conventional coronas turn-on, or begin to conduct electricity, at tens of kilovolts, but a micro-scale corona can turn on below 1000 Volts. A reduced voltage can be produced by smaller and cheaper components and makes the system more competitive.

### Ion Generation by Controlling Breakdown

A further method of EHD pumping that can be used in a cooling system according to the invention is described in detail in U.S. Pat. No. 7,214,949, entitled “Ion Generation by the Temporal Control of Gaseous Dielectric Breakdown,” the contents of which are incorporated by reference herein. This method includes adding additional electrodes (not shown in FIG. 1) close to the EHD electrodes (e.g. electrodes 102, 104) that initiate the breakdown of the nearby gas. The breakdown process includes applying a short duration (megahertz range frequency) pulse across the gas, between the ion generating electrodes. The pulse is halted before an arc is formed. The resulting breakdown produces ions which are then used for EHD pumping.

The advantages of this technique are that turn-on can occur at lower voltages than either of the above two corona methods. In addition, it does not rely on an electron avalanche, which is difficult to establish with electrode gaps below 100 μm and hence it can be effective in a smaller volume than the corona wind methods. Lastly, since it does not require a sharp electrode, sizes can be increased to simplify fabrication.

### Cooling System: Integration of an EHD Pump and Heat Sink

As mentioned above and illustrated in FIG. 1, a cooling system according to the invention integrates an EHD gas flow mechanism with a heat sink structure. Various structures and forms of integration will now be described in more detail.

FIG. 1 shows a first preferred embodiment suitable for all three EHD mechanisms mentioned above, although additional electrodes and elements (not shown) may be included for certain EHD mechanisms. As shown in FIG. 1, the first electrode 102 is located at the inlet of heat sink channel 110. The channel is representative of a multi-channel cooling system. The first electrode 102 can be a sharp electrode comprised of a thin wire and the second electrode 104 can be a blunt electrode comprised of a heat sink fin material such as aluminum.

In one corona wind example, gap 106 is about 30 mm, wire 102 has a diameter of about 0.5 mm. voltage source 108 is about 20 kV, fin 114 has a thickness (t) of about 1 mm, and channel 110 has a width (W) of about 5 mm and length (L) of about 100 mm.

In one micro-scale corona wind example, gap 106 is about 2 mm, wire 102 has a diameter of about 2 microns, voltage source 108 is about 1500 V, fin 114 has a thickness (t) of about 0.2 mm, and channel 110 has a width (W) of about 0.5 mm and length (L) of about 5 mm.

In one ion-generation breakdown control example, gap 106 is about 2 mm, wire 102 has a diameter of about 50 microns, voltage source 108 is about 1000 V, fin 114 has a thickness (t) of about 0.2 mm, and channel 110 has a width (W) of about 0.5 mm and length (L) of about 5 mm.

The present invention recognizes that enhancing the electric field strength at the first electrode (e.g. electrode 102) is important, especially in the establishment of a micro-scale corona. As set forth above, if the field strength at the first electrode is not sufficiently enhanced above the nominal value, then a corona will not form. To address this issue, another preferred embodiment is shown in FIG. 2 where first electrode 202 consists of a primary member with multiple electrodes 214 protruding from its sides. Each of the secondary tips 214 enhances the electric field beyond that found on the main element 216. Design of the secondary electrodes (length, spacing and effective diameter) can be optimized to maximize electric field enhancement and gas flow, while minimizing turn-on voltage and power consumption. In one example where gap 106 is about 2 mm and voltage 108 is about 1500 V, tips 214 are about 100 microns long, spaced by about 200 microns and have a diameter of about 2 microns.

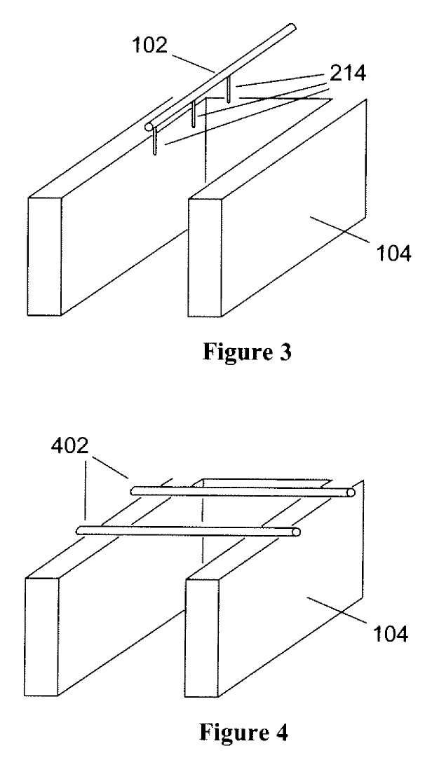

FIG. 3 shows another preferred embodiment that is similar to FIG. 2 except that the orientation of the secondary electrodes 214 is in the streamwise direction.

FIG. 4 shows another preferred embodiment employing multiple first electrodes for a single channel and second electrode. As shown in FIG. 4, rather than a single first electrode being oriented in a direction parallel to the heat sink structure associated with a corresponding second electrode (e.g. fin 112), two or more first electrodes 402 are oriented perpendicularly to the orientation of the second electrode (e.g. integrated in a heat sink fin 114).

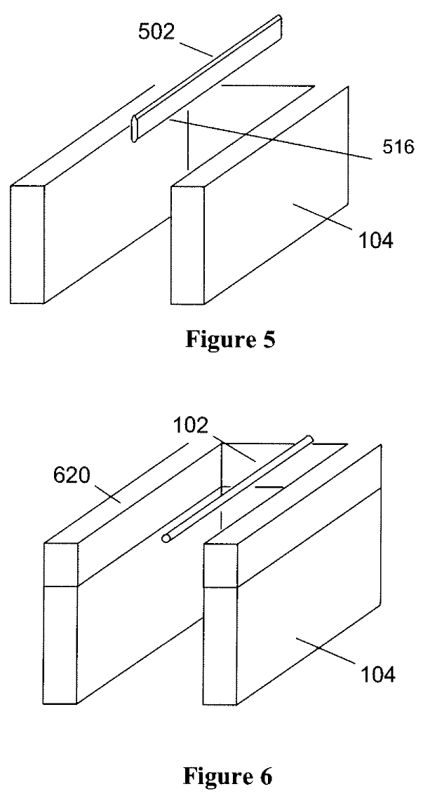

FIG. 5 shows another preferred embodiment with an alternate first electrode geometry. As shown in FIG. 5, first electrode 502 has a hexagonal cross-sectional shape, indicating that first electrodes according to the invention are not limited to having round cross-sectional shapes, and that other geometries can be designed based on a variety of factors. In this example, the hexagonal shape provides a sharp edge 516.

In the above embodiments, the EHD pumping occurs in the region between the heat sink and the first electrode. The present invention recognizes that it may be advantageous to confine the pumped fluid such that it is forced to pass through the heat sink channels. Accordingly, another preferred embodiment shown in FIG. 6 includes means to partially or fully surround the pumping zone. As shown in FIG. 6, the cooling system further includes a spacer 620 interposed in the gap between the first electrode and second electrode. The spacer 620 can be a dielectric or a conductor. In the instance that it is conductive, then it can be part of the second electrode. In this case the gap between the first electrode and the second electrode can be established by means such as a substrate for supporting the first electrode as will be described in more detail below. The spacer can also transfer heat from a heat source to augment or replace the heat sink. Another possible function of the spacer is to provide mechanical support for the first electrode element.

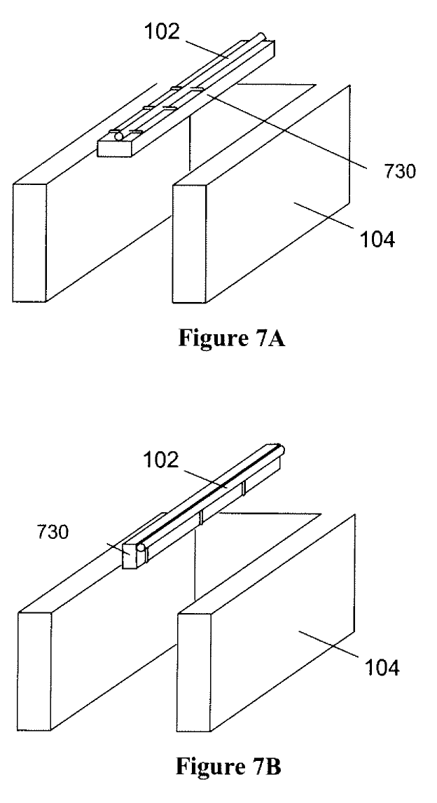

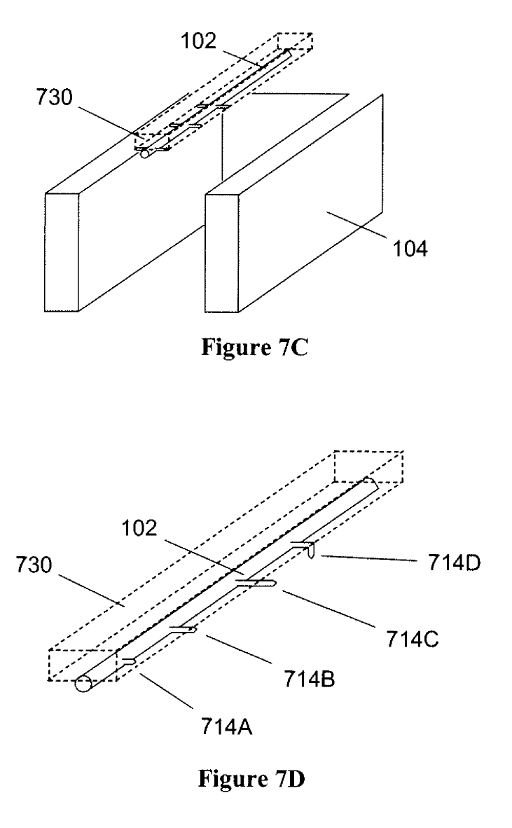

In some embodiments, the first electrodes may not be mechanically strong. This is especially pertinent to micro-scale corona electrodes. To anchor these electrodes, provide stability and to ensure reliable operation they can be supported by an appropriate structure such as a substrate. FIGS. 7A, 7B and 7C show preferred embodiments where the electrodes are located on the upstream wall, the side wall and the downstream wall, respectively, of a substrate 730. It should be apparent that other orientations and angles of the substrate and electrodes with respect to the stream direction are possible.

In embodiments where the first electrodes are in direct contact with a substrate, it is preferable for the electrodes to be terminated at the edge of the substrate surface or to extend a distance beyond the surface. In FIGS. 7B and 7C, the same advantage can be achieved by extending the ends of the electrodes at an angle to the substrate. FIG. 7D illustrates various configurations of first electrodes with respect to a substrate 730. As shown in FIG. 7D, electrode tip 714A is configured to be in contact with substrate 730 but to not extend to the edge of substrate 730. Electrode tip 714B is configured to extend such that it is even with the edge of substrate 730. Electrode tip 714C is configured to extend beyond the edge of substrate 730, and electrode tip 714D is configured to extend at an angle with respect to substrate 730.

In other embodiments, the electrode tips are not in direct contact with the substrate. These embodiments have improved electric field enhancement.

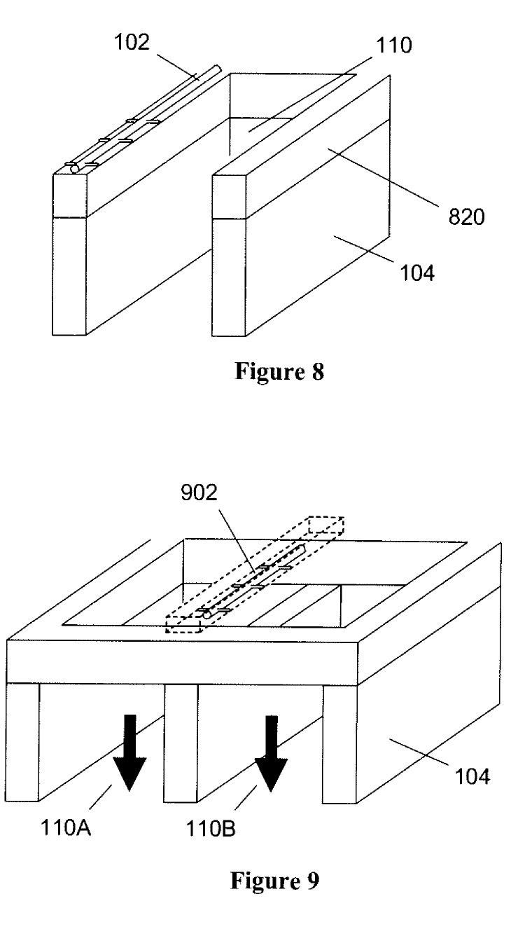

FIG. 8 shows an alternative preferred embodiment that can be useful for providing mechanical stability to an otherwise mechanically unstable first electrode structure. As shown in FIG. 8, the first electrode is provided on a substrate 820, which effectively combines a spacer and substrate into a single member. This embodiment further eliminates flow blockage that can be experienced when the first electrode element is located in the center of the channel 110.

### AC Voltage

Prototype devices were constructed similar to that shown in FIG. 8 and in accordance with the dimensions of the micro-scale corona techniques of the present invention. The devices were operated in air with DC voltages. Testing of these devices showed that the gas flow rate through the channels tapered off over time when the electrodes were held at a constant potential. It was discovered that under DC operation, surface charge builds up on any dielectric surface, for all types of pumping. This charge retards the field enhancement at the first electrodes, inhibiting the corona discharge and the formation of ions.

The present invention recognizes that one way to address this issue is to use an alternating (AC) EHD bus potential as the voltage source (e.g. source 108). The shape of the alternating bus potential is not limited to sinusoidal, but it can be square or pulsed, and variations thereof. The alternating current moves bi-polar ions between the electrodes. Since both positive and negative charges are present in the channel neither species is able to build up on dielectric surfaces. These surfaces remain essentially neutral and hence do not retard the electric field at the first electrodes. FIG. 11 is a graph showing the typical dependence of thermal resistance on the applied frequency in a structure such as that shown in FIG. 8 and using a micro-scale corona wind EHD pumping technique. As shown in this example, the thermal resistance is lowest when the cooling system operates in the frequency range between 1 and 100 kHz. The optimal operating frequency of AC current thus lies in this range.

Cooling System with Large Micro-Channel Array

A preferred type of heat sink structure to be integrated with an EHD pump mechanism according to the invention is one with a large parallel array of relatively short micro-channels; although many other types of heat sinks can be used. Depending on the heat sink fin width and channel width, however, placing first electrode elements on adjacent fins may reduce the field enhancement and thus the pumping performance. A preferred embodiment that addresses this issue is depicted in FIG. 9 where a single first electrode element 902 is used to provide pumping for multiple channels 110-A and 110-B. This increases the available space between neigh9boring electrodes and enhances the cooling performance.

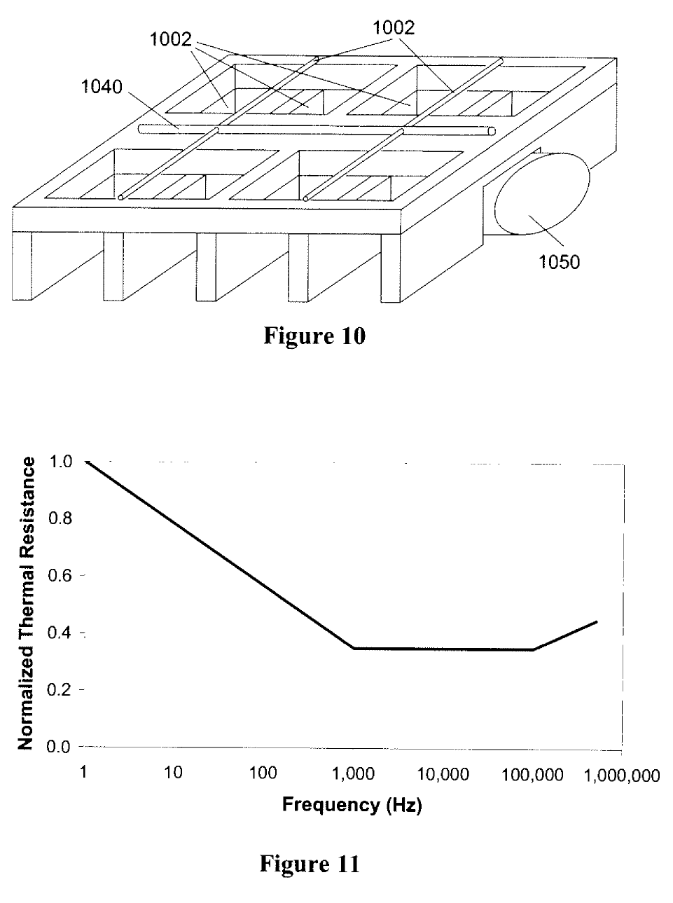

One preferred heat sink structure has been described in co-pending U.S. patent application Ser. No. 11/181,106, entitled “Micro-Channel Heat Sink,” the contents of which are incorporated by reference herein. The EHD electrodes can be located on either the top or bottom side of the channels in this type of structure. FIG. 10 depicts a preferred embodiment of the invention with an overall heat sink structure such as that described in the co-pending U.S. patent application Ser. No. 11/181,106. As shown in FIG. 10, the array of first electrode elements 1002 is distributed across the inlets of an array of channels 110. The first electrode array is electrically tied to a central corona bus 1040 to which the voltage is applied.

It should be noted that FIG. 10 shows an embodiment of a cooling system that employs a heat pipe 1050 as means to deliver heat from a heat source to the heat sink channel walls. In embodiments including a corona-type EHD pumping system, the heat pipe 1050 can also act as a second electrode. It should be noted that in other embodiments, the heat sink structure may be more directly thermally coupled to a heat source rather than remotely through a heat pipe.

Cooling System with Controlled Breakdown Ion Generation

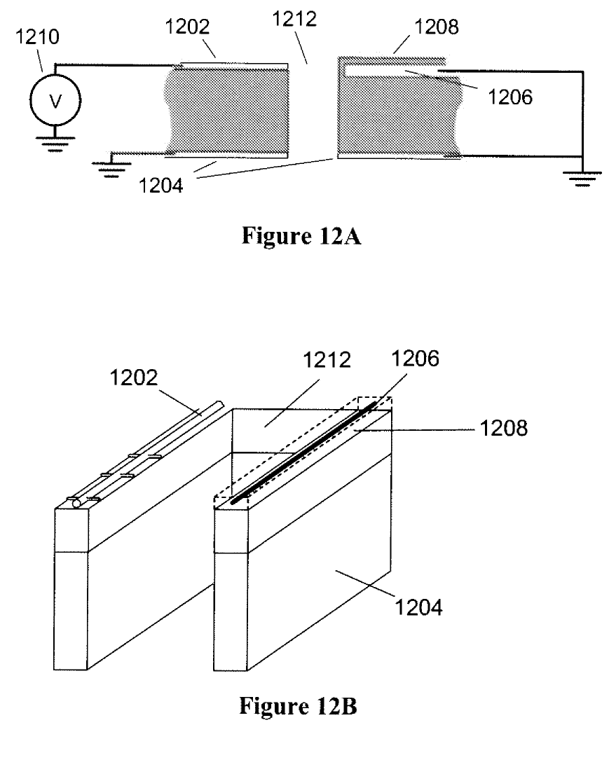

As mentioned above, although the same overall heat sink structure and ion-generating electrodes can be used, the embodiments shown in FIGS. 1 through 10 may require additional electrodes and structure to accomplish the EHD pumping method described in U.S. Pat. No. 7,214,949. FIG. 12A shows schematically how various embodiments of the invention can be realized in an actual application. The example implementation of FIGS. 12A and 12B contain a first electrode 1202 and second electrode 1204 similar to the corona wind embodiments. In addition, this embodiment includes a third electrode 1206. (It should be noted that the designators “second” and “third” electrodes are reversed between this and the co-pending application). FIG. 12A shows a cross-sectional view of a representative cooling channel. FIG. 12B illustrates one example of how the additional electrode 1206 may be embodied in a heat sink structure such as that described in connection with FIG. 8 above.

The material for the third electrode 1206 can be aluminum or any conductor, having a thickness of about 500 nm and can be covered by a thin dielectric 1208 of, for example, polyimide having a thickness of about 1 micron. Voltage source 1210 is on the order of 1000 V and is temporally controlled as described in the co-pending application to first cause the gas gap between electrodes 1202, 1206 to begin to break down. The process is halted as charge accumulates on the surface of the dielectric 1208 covering the electrode 1206. Thus the dielectric coating acts as a capacitor. However, the thin dielectric 1208 allows charge to slowly leak off of the surface and to the electrode. Thus the dielectric coating also acts as a resistor by allowing charge to leak through and discharge the capacitor. Ions are formed at the channel inlet 1212 and are drawn by a secondary field established by the second electrode 1204, which is held to a ground potential.

Cooling System with Remote Heat Dissipation

The cooling system shown in FIG. 10 is one embodiment of a system according to the invention that is capable of being located away from the heat source. As described above, this device is thermally coupled to the heat source by one or more heat pipes. In the example shown in FIG. 10, the heat pipe runs along the center of the heat sink, although several other configurations are feasible. Heat is transported from the heat pipe to the base of each fin that forms the heat sink channels. The simple conduction path allows the heat sink to be made thinner than would be possible without the heat pipe. The short conduction paths also make it feasible to use many different materials for the heat sink (aluminum, silicon, carbon fiber, steel, alumina etc.), since high thermal conductivity is not a necessary material requirement.

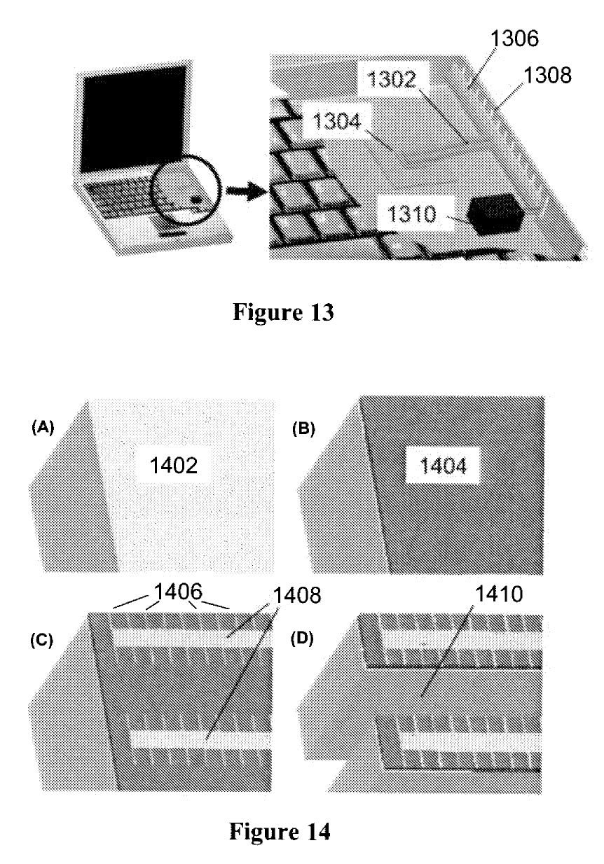

One possible application of a complete cooling system according to the invention for a laptop computer is shown in FIG. 13. The complete system has a heat pipe 1302 to transport heat from the central processing unit 1304 to the EHD gas flow heat sink 1306. The heat pipe can be a standard, commercially available device consisting of a two-phase fluid and a wick inside a tube, but the invention is not limited to such particular devices. The heat pipe device efficiently transports heat by evaporating fluid from one end of the tube and condensing it to the other. The heat sink is located near a side wall with a vent 1308 so that hot gas is exhausted outside of the computer in this example. A power supply 1310 provides alternating current to drive the EHD gas flow unit.

The cooling system of the invention can also be applied to other electronic equipment such as desktop computers, servers, communication equipment, cable set-top boxes, video game machines, digital and analog televisions and displays, hand-held personal digital assistants, cell phones, etc. According to certain aspects, the EHD pump applications and configurations described in this invention have several advantages. For example, because of their reduced form factor and size, the EHD pumps of this invention can operate at lower voltages and require lower energy levels than other EHD pumps known in the art. This makes operating the EHD pumps of this invention much safer because it immediately reduces the risks of an electric shock, reduces the amount of ozone which may be generated, and allows much better control of the voltage and current to avoid sparks and/or arcs. The electrodes of the EHD pump of this invention, for example electrode 102 or electrode 502, thus are less fragile such that the EHD pumps are more robust against mechanical shocks. This mechanical robustness can be further enhanced by mounting electrodes on a substrate, such as, for example, substrate 730. Furthermore, the substrate 730 can also shield the electrodes from dust flowing along with the airflow. If, for example, the electrodes sit down-wind from the substrate as in FIG. 7C dust can not build up on the electrodes therefore avoiding all negative side-effects of dust in electrostatic devices.

Applying the novel cooling system of this invention to certain types of LED cooling is a non-trivial task. For example, the EHD pump should be very energy efficient and use low power to maintain the energy efficiency of LED lighting; the EHD pump should be “instant-on” to immediately remove the heat because the small dies of LED devices generate heat instantaneously when switched on and would overheat otherwise; also, the EHD pump should have a lifetime comparable if not longer than the LED itself (which is expected to operate for more than 100,000 hours) or upon failure to cool the LED the system may overheat leading to a potentially hazardous situation. Because LEDs support many switching cycles (typically more than 10,000 which is much more than incandescent light bulbs support) the EHD pump for cooling should also support that many switching cycles without failure. Additionally, the EHD pump should be noiseless to be useful in many applications such as in-door lighting. Noiseless operation also requires avoiding sparks and arcs, for example. The EHD pump should be safe and reliable. This means that the EHD pump must not be sensitive to dust, shocks, vibration etc., that the EHD pump should not generate any hazardous amounts of ozone, and that the EHD pump—including a possible anti-ozone coating—should be tolerant to high temperatures of over 100° C.

The following detailed descriptions of embodiments of the present invention elaborate on the various aspects of an EHD pump suitable for LED cooling and describe various methods and systems which utilize EHD pumps for LED cooling. One fundamental principle behind our invention is to use an EHD pump to generate airflow which, compared to passive cooling approaches, increases the so-called heat coefficient of a LED cooling system.

An embodiment this invention is an active LED cooling system which is noiseless and does not comprise any moving (e.g. rotating) parts to generate an airflow. In another embodiment, airflow is generated by a corona wind and thus can be seen as a solid-state LED cooling system. In another embodiment the cooling system comprises one or more EHD pumps complemented by one or more heat sinks which remove the heat from the LED into the ambient air, for example. In yet another embodiment the cooling system comprises one or more EHD pumps and one or more heat pipes, such as, for example, heat pipe 1060 in FIG. 10 or heat pipe 1302 in FIG. 13, adapted for embodiments to be described in more detail below, to transport heat away from the LED to a spot more suitable for release. The airflow in this invention can be a laminar or turbulent airflow, or the airflow can be a crossflow across the one or more heat sinks, or the airflow can impinge on one or more heat sinks, or the airflow can be a combination of both, or the airflow can be a uni-directional airflow, or the airflow can be a multi-directional airflow. In one embodiment one or more EHD pumps can create an airflow with enters and leaves the LED lighting device at the same side forcing the airflow to perform a so-called U-turn. Such an airflow may be advantageous, for example, when LED lighting devices are mounted in a dropped ceiling and the cool air must come from the free space underneath the ceiling and the hot air must be blown out into that free space because the space above the dropped ceiling may not be sufficient for ventilation. Another use case for airflow to perform a U-turn is when LEDs are mounted in restricted spaces. And in yet another embodiment the airflow can be used to break up the so-called boundary layer to further increase the heat coefficient.

In one embodiment the EHD-based LED cooling system can be instant-on to generate an airflow for cooling immediately after the LED was switched on. In another embodiment the EHD pump can generate an airflow which slowly increases—ramp-like—until a certain level. In yet another embodiment a closed-circuit control system can control the one or more EHD pumps, and thus the airflow, based on temperature, or temperature differences between two or more locations, or electrical power used by the LED, for example. Cooling can mean that intrinsic heat which is generated by the LED itself is removed from the LED, or cooling can mean that heat from an external heat source adjacent to the LED is removed, or cooling can also mean that heat generated from other sources heating the LED, for example, sun light, is removed.

In one embodiment the EHD-based LED cooling system can be used to cool one single LED, for example one high-power lighting LED. In another embodiment the EHD-based cooling system can be used to cool multiple LEDs at the same time, for example, multi-LEDs for mixing colors. In yet another embodiment the EHD-based cooling system can cool entire assemblies of LEDs, for example LED panels or displays, at once. In one embodiment the airflow can enhance the heat convection at the backside of such an assembly or panel. And in another embodiment the EHD-based cooling system can cool many LEDs mounted on a printed circuit board by forcing airflow through vents manufactured into that printed circuit board. With the small form factor of EHD pumps (i.e. much smaller size and/or weight as compared to conventional cooling mechanisms such as fans) it also becomes feasible to partition LED assemblies or LED panels into multiple zones and to cool each zone independently. It also becomes feasible to have separate control measures for controlling the EHD pumps, and thus the airflows, on a per zone basis. The compact form factor of EHD pumps such as those described above in connection with FIGS. 1-8 also makes it possible to cool certain LEDs which are built into cameras, for example, to provide light during filming. Such lighting LEDs for cameras can be of any light color, including infrared light.

Other use cases of this invention are to cool LED lighting in industrial or residential applications, or to cool LED lighting for automotive applications, or to cool LED lighting for stage lighting. And yet another use case for EHD-based LED cooling is when high-power LEDs are used in projection systems, for example the projection systems described in U.S. Pat. No. 7,252,385, in U.S. Pat. No. 7,296,898, or in U.S. Patent Publication No. 2009/0059580. And, according to further aspects of the invention, an EHD pump can also be applied for cooling other projection systems which use incandescent lights such as in U.S. Pat. No. 6,254,238, in U.S. Pat. No. 6,523,959 and others.

Yet another use case of this invention to cool LED lighting is in conjunction with structures such as U.S. Patent Publication No. 2005/0111234 named “LED Lamp Heat Sink” by Martin et al. where a fan, for example the fan 442 of FIG. 7 of that Patent Application Publication, can be replaced by an EHD pump. EHD pumps can not only be located in close distance of the LED chip but also remotely when the heat can be transported through an air duct and/or a heat pipe (e.g. heat pipes such as those shown in FIGS. 10 and 13 above, adapted for use with this embodiment).

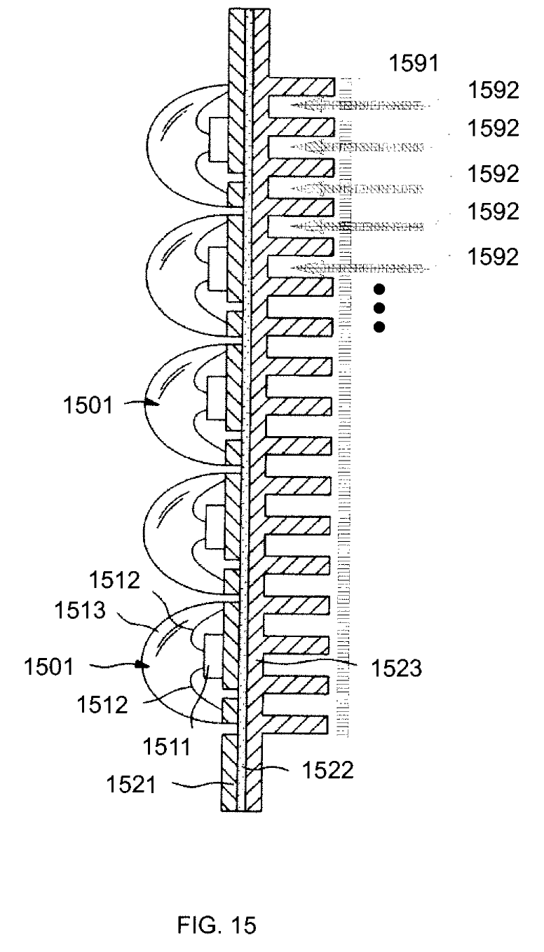

As illustrated in FIG. 15 of the accompanying drawings for a heat sink construction a circuit layer (not illustrated) is provided on a circuit board 1521; a light emitting chip 1511 can be mounted to the circuit layer, followed with bonding a wire 1512 to connect its corresponding circuit on the circuit board 1521 before being molding with an adhesive layer 1513 to form a light emitting diode 1501. Whereas the LED 1501 can be connected through the circuit on the circuit layer, the LED 1501 may be interconnected to and subject to the control by an external control/drive circuit through the circuit layer. A heat sink 1523 can be fixed using a thermal adhesive 1522 below the circuit board 1521 of the LED 1501 so that heat generated by the working LED 1501 can be transmitted by the thermal adhesive 1522 to the heat sink 1523 having multiple fins. According to aspects of the invention, EHD pump 1591 can be placed adjacent to the heat sink 1523 to generate an airflow 1592 for improved heat removal.

LED 1511 can be embodied using various types of current and future LED devices including types of LEDs described in the background section of the present application. EHD pump 1591 can be embodied by using any of the structures or techniques described in connection with FIGS. 1 to 8 above. Those skilled in the art will understand how to adapt such structures and/or techniques for use in the configuration shown in FIG. 15 after being taught by the disclosures herein. For example, EHD pump 1591 can have a separate collector electrode, or EHD pump 1591 can have one or more collector electrode(s) that are integrated with heat sink 1523 as described above.

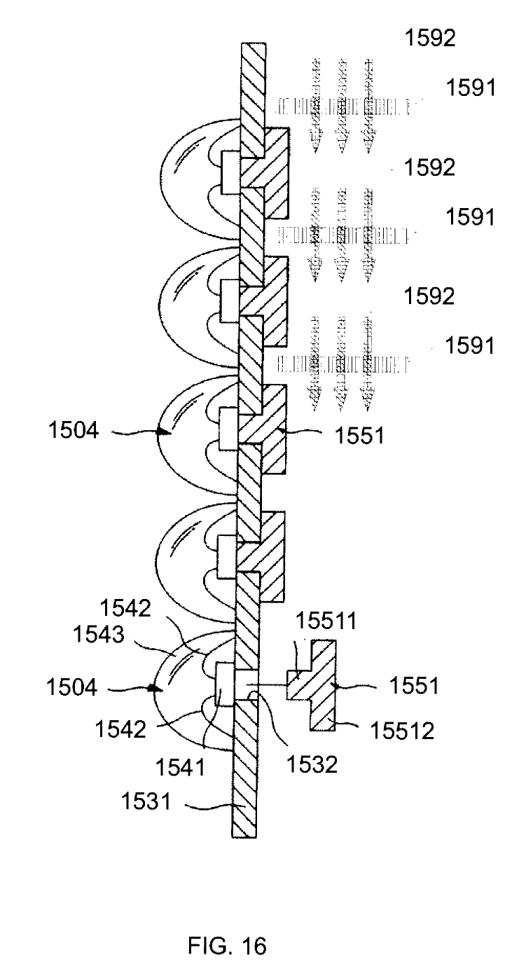

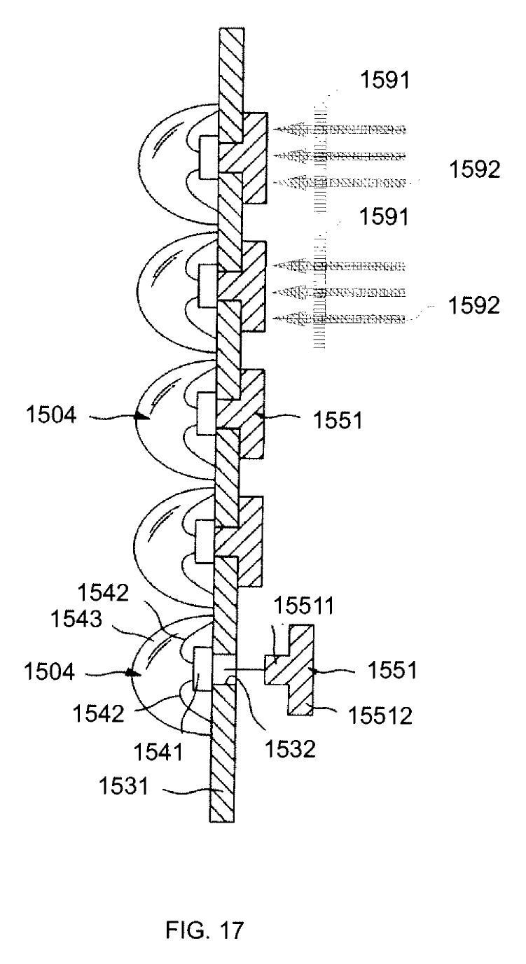

Referring to FIGS. 16 and 17 for a light emitting diode heat sink construction of a preferred embodiment, a circuit layer (not illustrated) is disposed on a circuit board 1531, a light-emitting chip 1541 can be mounted to the circuit layer, and a gold plated wire 1542 can be bonded to connect its corresponding circuit on the circuit board 1531 before being molded into an adhesive layer 1543 to become a light emitting diode 1504. A through hole 1532 can be disposed on the circuit board 1531 corresponding to where the light-emitting chip 1541 is located. The through hole 1532 can be connected with a heat dissipation means to directly contact and cool the light emitting chip and cool it. The heat dissipation means relates to a heat sink 1551 made of metal (aluminum or copper), ceramic compound, graphite compound or polymer admixed with metal oxides. The heat sink 1551 penetrates into the through hole 1532 to define a locating portion 15511, a heat dissipation portion 15512 providing a greater contact surface for heat dissipation to further extend the locating portion 15511. A locating means, e.g., an adhesive 1552 can be provided between the through hole and the heat sink 1551 to secure the heat sink 1551, or the heat sink 1551 can be secured to the through hole by using a soldering method. The adhesive 1552 may be related to a polymer, thermal adhesive, thermal past, or phase change material (PCM). In one embodiment, the heat sink 1551 can be secured to the circuit board 1531 in position by means of the through hole 1532 so to directly contact the light-emitting chip 1541. Whereas the heat sink 1551 can be provided with a heat dissipation portion 15512 with a greater contact surface to permit the heat generated from the working light emitting diode 1504 to be effectively dissipated. Because the EHD pump of this invention is highly versatile and can be built for many different form factors, various possibilities exist to improve the cooling efficiency. For example and as shown in FIG. 16, one or more EHD pumps 1591 can be put adjacent to the heat sink 1551 to provide a crossflow 1592 for active cooling of LED 1504. In another example, as shown in FIG. 17, one or more EHD pumps 1591 can be put adjacent to the heat sink 1551 to provide an impinging airflow 1592 for active cooling of LED 1504.

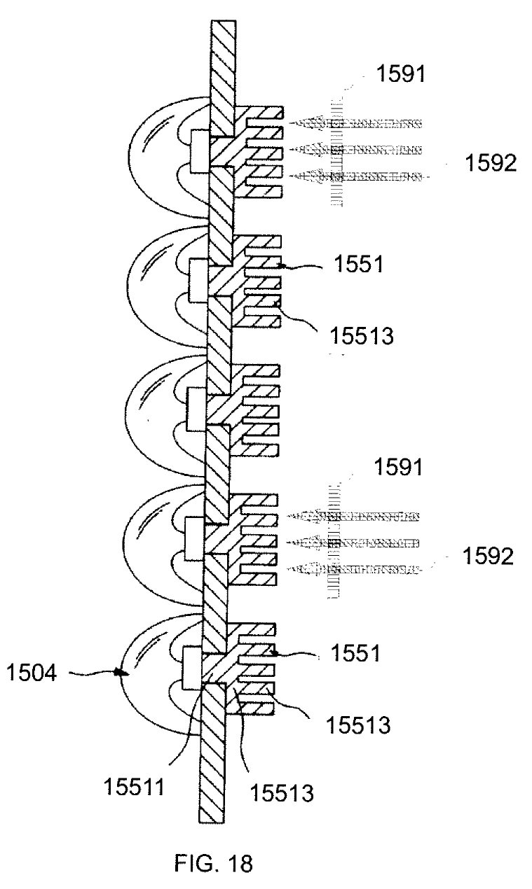

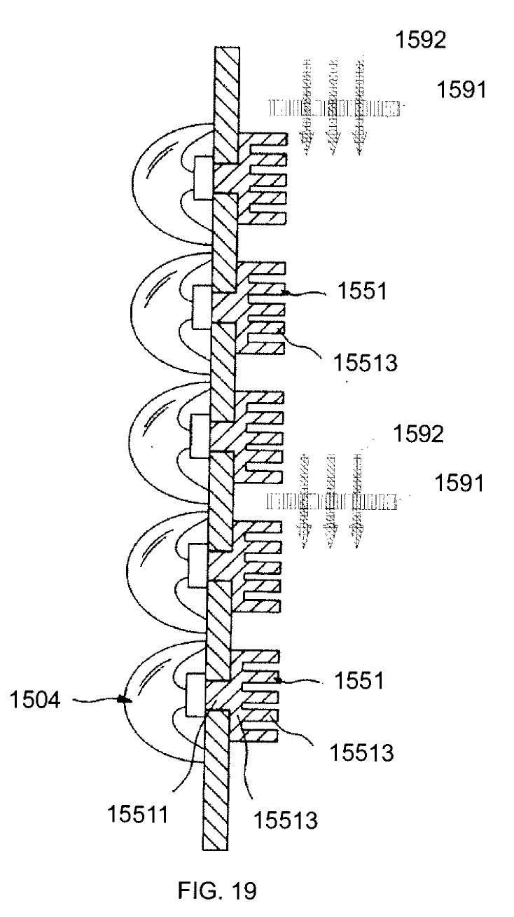

Correspondingly, as illustrated in FIG. 18 and FIG. 19, the heat dissipation portion 1551 can have multiple fins 15513 to increase the heat coefficient for further improvement. Again, one or more EHD pumps 1591 can be put adjacent to the heat sink 1551 to generate an impinging airflow 1592, as in FIG. 18, or a crossflow 1592 as shown in FIG. 19.

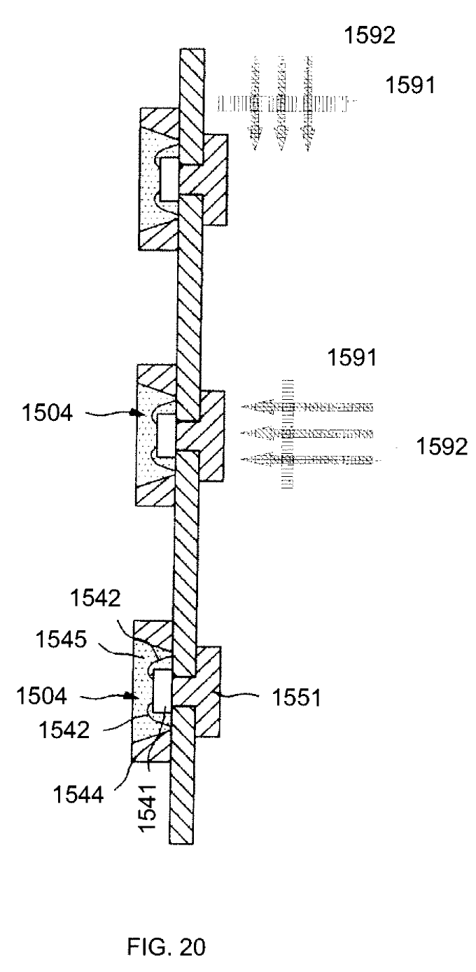

The present invention recognizes that still further possibilities exist to complement heat sinks for LEDs with EHD pumps. For example, referring to FIG. 20 an insulation base 1544 can be provided on the circuit board 1531 and the light-emitting chip 1541 can be fixed in the insulation base 1544. Similarly, the gold plated wire 1541 can be bonded to connect to its corresponding circuit on the circuit board 1531, and a sealant can be poured into the insulation base to form a protection layer 1545 to complete the assembly of a light-emitting diode 1504. This allows heat dissipation by having the light emitting diode to directly contact the heat sink 1551 and, according to aspects of the invention, the cooling can be enhanced by putting an EHD pump 1591 adjacent to the heat sink 1551 to generate airflow 1592 for active cooling.

FIG. 20 also highlights another important aspect in cooling using the EHD pumps of this invention: A turbulent airflow can be generated by having one or more EHD pumps generating an impinging airflow while one or more EHD pumps generate a crossflow. Such a turbulent airflow may be advantageous, for example for breaking up the warmest layer of air closest to a hot surface—the so-called boundary layer—to further improve cooling efficiency.

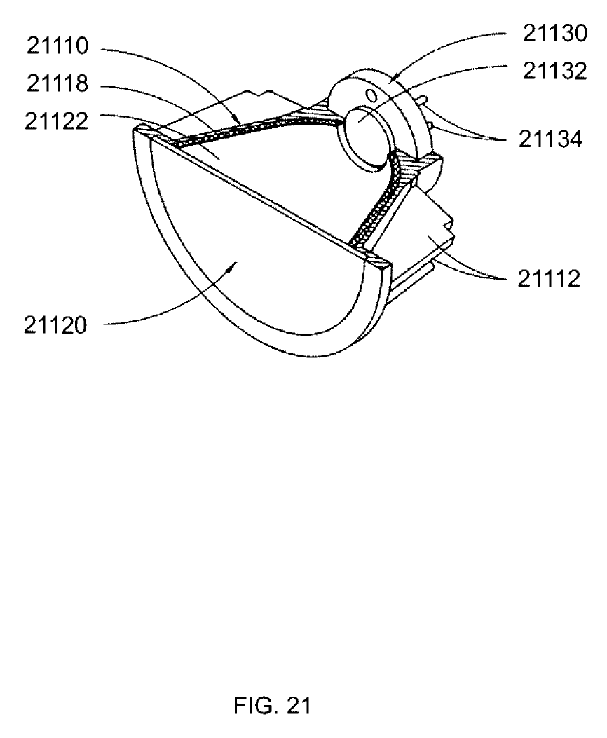

Referring to FIG. 21, a structure diagram of a heat sink for a lamp having a light emitting diode is illustrated. The heat sink comprises a heat sink module 21110, a transparent lens 21120 and an illumination module 21130. The heat sink 21110 is formed by the heat condition materials for heat sinking. The heat sink 21110 also has a plurality of cooling fins 21112 surrounding it for increasing the heat coefficient. Besides, a lamp house 21122 is also included in the heat sink module 21110 with a first opening and a second opening on both ends. Moreover, the transparent lens 21120 and the illumination module 21130 are used for sealing the first opening and the second opening separately. Furthermore, the heat sink can further comprise a sealed room 21118 filled with a heat conduction liquid for enhancing the cooling effect of the heat sink 21110. The room 21118 can surround the lamp house 21122 for conducting the heat to each cooling fins 21112. According to one preferred embodiment of the present invention, the heat conduction liquid can be the ultra pure water, high thermal conductive liquid or high thermal conductive mixed liquid. The foregoing illumination module 21130 comprises at least one light emitting diode configured on the surface of the illumination module 21130 toward the lamp house. A light guiding material 21132 can cover the light emitting diode or light emitting diodes. The light guiding material can be transparent or opaque. In addition, the illumination module 21130 further comprises a plurality of terminals configured on the surface of the illumination module 21130 backward the lamp house 21122. The terminals are used for electrically coupling an external electrical power for illumination. The foregoing external electrical power can be an alternating current or a direct current. The external electrical power is optional according to the type of the illumination module 21130.

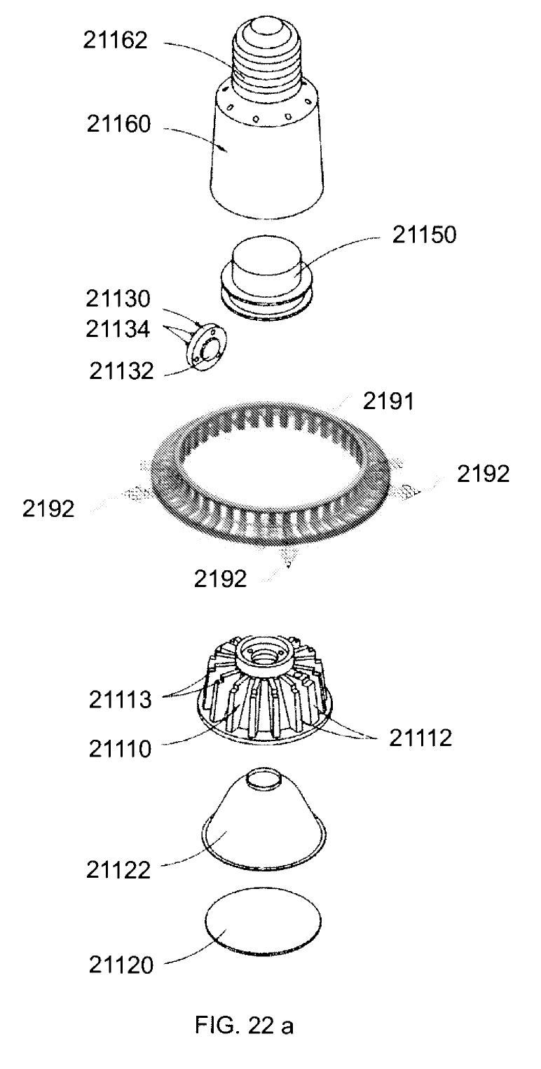

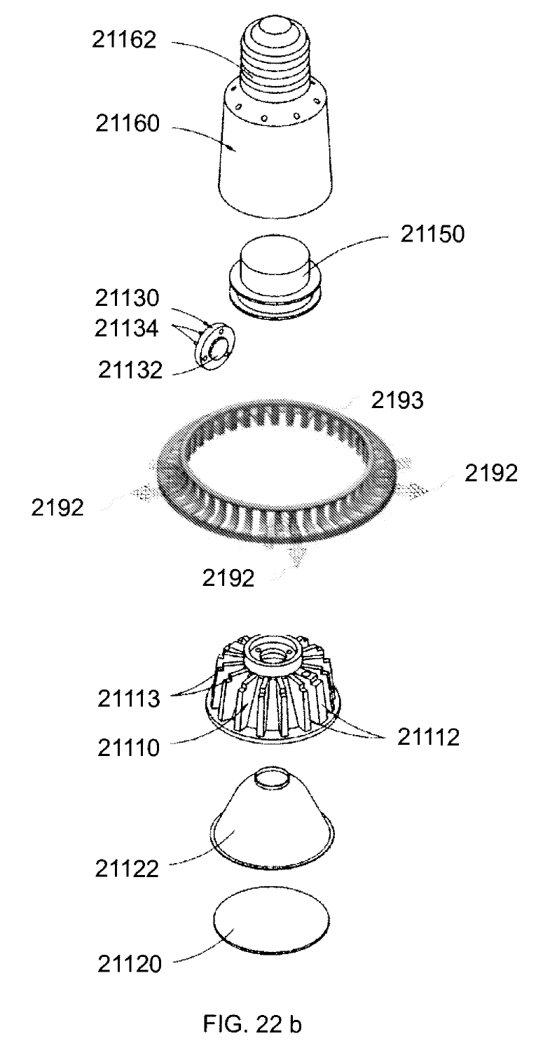

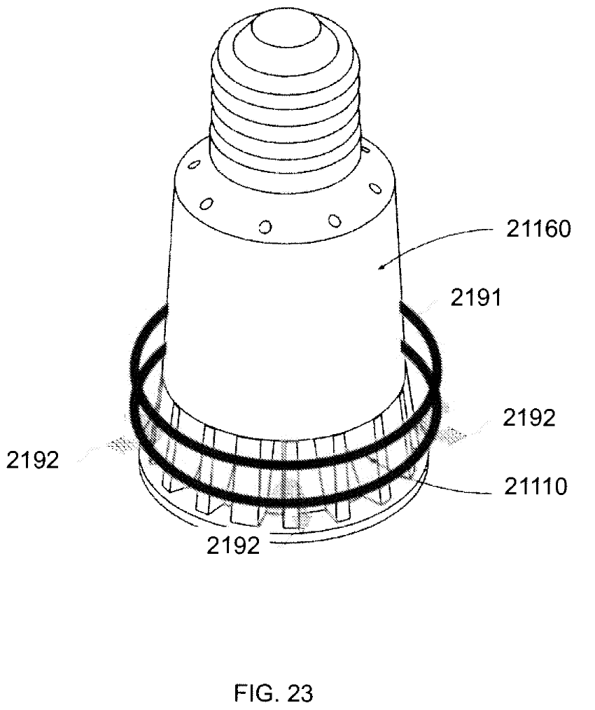

Referring to FIG. 22a, 22b and FIG. 23, the tail of the heat sink module 21110 can be connected to a connector 21160, the connector 21160 can include a screw cap 21162 as the interface for connecting the socket for a light bulb. The external electrical power is supplied via the socket for a light bulb. The standards of the screw cap can be the well-known E27, E39 and so forth. The present invention does not limit the manner for connecting the connector 21160 with the heat sink module 21110. For example, there can be a indentation on a corner of each cooling fin 21112, whereby connector 21160 can be connected on the indentations of the heat sink 21110. Furthermore, another embodiment of the present invention can further use an AC/DC converter (alternating current/direct current converter) module 21150. The AC/DC converter can convert the alternating current in the external electrical power into the direct current for providing to the terminals 21134.

Now, to enhance the heat coefficient an EHD pump 2191 can generate an airflow 2192 for active cooling. In one embodiment, this airflow 2192 can perform a “U-turn” like motion to remove the heat from heat sink 21110. As a beneficial side effect this airflow 2192 can also break the boundary layer to further enhance the heat coefficient. When adding EHD-based cooling an EHD pump 2191 can be added which itself can generate an airflow, as it is described, for example, in FIG. 22a. Or, an EHD pump 2193 can be added which uses one or more heat sinks 21112 as collector electrodes, as it is described, for example, in FIG. 22b.

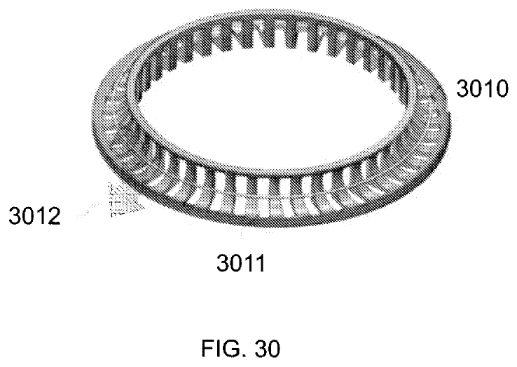

In this case the EHD pump has a ring-like shape, such as the toroidal EHD pump of FIG. 30. The toroidal EHD pump follows the same principles as the EHD pump of FIG. 1 and has a first electrode 3010, which can correspond to the first electrode 102, and a second electrode 3011, which can correspond to the second electrode 104. Both electrodes 3010 and 3011 are separated by a gap and ion generation across that gap causes airflow 3012. Because of the shape of the EHD pump, the direction of this airflow 3012 may follow a curve. It should be noted that the pump illustrated in FIG. 30 is adapted for use with cooling LEDs in accordance with the present invention, but is not limited to such an application.

LED(s) in module 21130 can be embodied using various types of current and future LED devices including types of LEDs described in the background section of the present application. EHD pump 2191 or 2193 can be embodied by using any of the structures or techniques described in connection with FIGS. 1 to 8 above. Those skilled in the art will understand how to adapt such structures and/or techniques for use in the configurations shown in FIGS. 21-23 after being taught by the disclosures herein. For example, EHD pump 2191 or 2193 can have a separate collector electrode, or EHD pumps 2191 or 2193 can have one or more collector electrode(s) that are integrated with heat sink fins 21112 as described above.

FIG. 23 provides an external view of a lamp constructed using the components described in connection with FIG. 22a. The drawing details of EHD pump 2191 have been omitted in FIG. 23 for clarity of illustration.

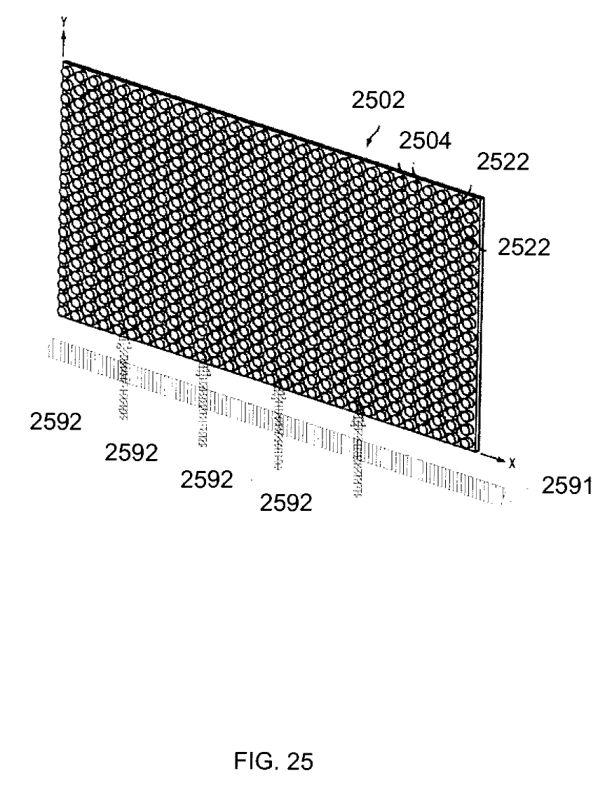

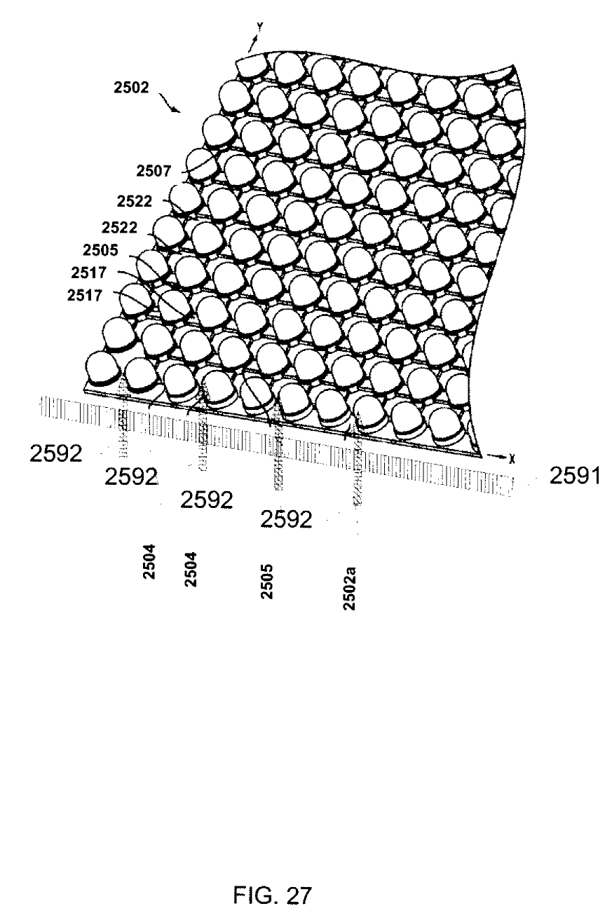

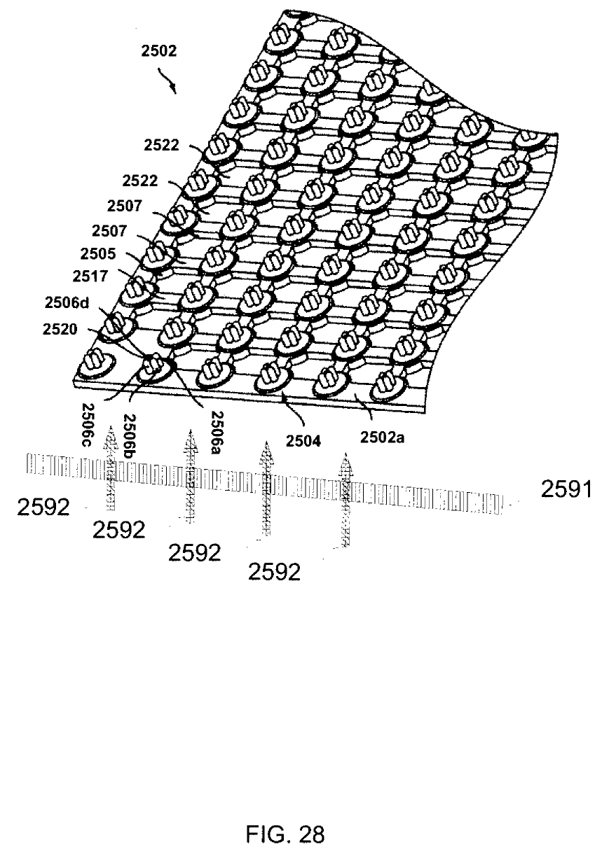

FIGS. 25-29 illustrate an embodiment of a printed circuit board (PCB) assembly 2502 including an array or grid pattern of light emitting diode (LED) modules 2504 mounted thereon forming a so-called LED panel. In one arrangement, the LED modules 2504 are disposed at intersecting junctions 2505 of the PCB assembly 2502 in a generally perpendicular X-direction and Y-direction based on a Cartesian coordinate system. The junctions 2505 (see FIG. 27 or FIG. 28) are interconnected by a plurality of bridges 2517 defining vents 2522, which may be drilled or routed in the printed circuit board. While the terminology “printed circuit board” is used for ease of reference, it should be understood that other types of circuit boards other than printed boards may be used, and such boards are intended to be encompassed within the term “printed circuit board” or PCB. Examples may include embedded wires, ribbon cables, or similar structures. The vents 2522 can have various shapes and dimensions. For example, vents 2522 can be smaller than LED module 2504, in which case the LED modules are very densely packed on the PCB. Or the vents 2522 can be many times larger than LED modules 2504, in which case the LED modules are very sparse.

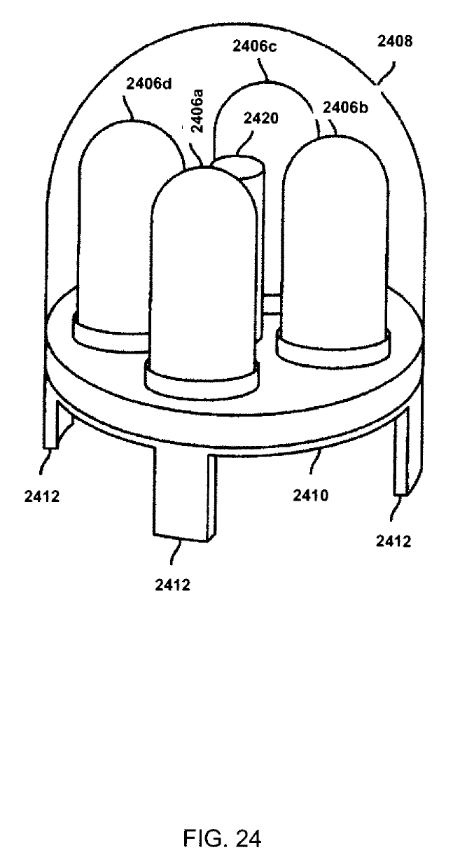

FIG. 24 illustrates an example embodiment of an LED module 2504 according to one or more aspects of the present invention. As shown in FIG. 24, LED module 2504 may include one or more LEDs 2406a-d disposed within the interior cavity of a removable translucent dome or cap 2408. The cap is optional and may not be required in all applications. Moreover, while four LEDs 2406a-d are shown, the LED module 4 may have more or fewer LEDs depending on the acceptability for the intended use. In one variation, an LED module may consist of a single LED mechanically attached by, for example, soldering to the circuit board.

LED 2406 can be embodied using various types of current and future LED devices including types of LEDs described in the background section of the present application.

The dome 2408 may be formed of several alternative materials, such as a translucent plastic or glass. Various materials may be selected for atmospheric environments based on the intended use. An appropriate material and thickness characteristics enables the dome 2408 to protect the LED 2406a-d against physical impingement from flying projectiles in the air or rain, and may help in reducing aerodynamic drag on the assembly. Dome 2408 can be optically neutral to preserve the optical characteristics of the LED 2406a-d, such as field-of-view focusing. Alternatively, dome 2408 may also have optical properties that enhance those of the LED 2406a-d, such as lowering the side leakage. The material may also protect the LEDs 2406a-d from UV damage that may discolor the optical material or other internal components. The UV protection helps to mitigate brightness reduction of the LEDs 2406a-d over time due to exposure to external UV wavelengths. The dome 2408 may be removably mounted via a friction-fit engagement to a base member 2410. Alternatively, dome 2408 may be mounted to the base member 2410 m other ways, such as in a snap-fit or threaded engagement. The removable arrangement of the dome 2408 provides access for field or bench-level maintenance, such as replacement or upgrade to the LED 2406a-d or other components of LED module 2404. LED modules may be removed from the PCB assembly for maintenance and the like. Various techniques may be implemented to permit an LED module to be serviced without being completely removed. For example, the LED module may be attached to the board by a hinge or similar mechanism such that it can be opened without being removed.

In one variation, base member 2410 includes extension members or protrusions 2412 that may be utilized for mounting the LED module 2504 to the PCB assembly 2502. In one configuration, the extension members 2412 may provide a partial heat transfer path for cooling the LED module 2504 in conjunction with PCB 2502 assembly substrates. The base member 2410 may be composed of a number of alternative materials, including copper, aluminum, or a mixture of metal particulates suspended in a plastic material, carbon fibers or other well known material that provides thermal conductivity without electrical connection.

With continued reference to FIG. 24, in one arrangement, the base member 2410 may have an annular or circular shape. Alternatively, base member 2410 may be formed in several shape configurations depending on the intended use of the LED module 2504. A peripheral surface of the base member 2410 may retain a sealing member. The sealing member may be configured to prevent debris and other external environmental components from entering into the interior cavity of the LED module 2504 formed between the dome 2408 and base member 2410. The sealing configuration with the dome 2408 also provides protection of the LEDs 2406a-d against environmental conditions, such as temperature, humidity, salt, acid rain and the like. The sealing member can be formed in several shapes and mounted to the base member 2410 using conventional methods and techniques. For example, the sealing member can be formed as an annular ring, such as an O-ring. Further, the sealing member may be composed of a resilient material, such as rubber or a synthetic rubber. For mounting arrangements, the sealing member may be adhesively bonded to the base member 2410. Alternatively, the sealing member can provide compression forces for a friction fit engagement with the base member 2410.

With reference to FIG. 24, each LED 2406a-d includes two electrical leads physically connected to respective electrical conductors. Lead material and length may be selected to maximize thermal connection between LED and circuit board for heat dissipation, as discussed in more detail below. The LED module may have other alternative configurations. For example, the LED module may be surface mounted or a direct-on-die arrangement on the PCB assembly substrate. In such a surface mount configuration, the leads are connected to electrical conductors or traces.

In the most basic configuration, a single LED may be placed at each junction, and may be selectively illuminated by energizing a corresponding X-wire conductor and Y-wire conductor, such that the LED at the junction of the X-wire conductor and Y-wire conductor causes the LED to be illuminated. In other embodiments, more than one LED may be affixed to each junction, such that a single X-wire conductor and Y-wire conductor when energized cause all of the LEDs at the junction to be illuminated. In yet other embodiments, a plurality of X-wire conductors and a plurality of Y-wire conductors (e.g., two in each direction) overlap at the junction, such that more than one pair of conductors is available to selectively illuminate one or more LEDs at the junction. Drivers of various types may be used in association with the LEDs, such that signaling is provided on one set of conductors while power is provided by means of other conductors. In some embodiments, multiple LEDs at the junction may be selectively energized by means of a decoder that decodes signals on corresponding X-wire conductors and Y-wire conductors such that a larger number of LEDs can be selectively illuminated using a smaller number of conductors.

The LED module 2504 may include a decoder unit which may be configured for control of energizing or de-energizing each respective LED 2506a-d. Each decoder unit may be responsive to computer readable commands intended for controlling each LED 2506a-d. Alternatively, each LED 2506a-d within the module 2504 may be energized simultaneously for increased illumination and brightness characteristics depending on the intended application. For example, applications that may utilize the PCB assembly 2502 could be a vehicular or aircraft traffic signage; large screen video displays; and computerized video billboards and the like.

In the arrangement shown in FIG. 24, the LED module 2504 may include a heat resistor 2420 disposed between the LEDs 2406a-d. The heat resistor 2420 may be energized when defogging or deicing of the dome 2408 or other internal components is needed.

FIGS. 25-28 illustrate different arrangements of the PCB assembly 2502 for providing heat dissipation for cooling the LED modules. The PCB assembly 2502 includes thermodynamic cooling features and aerodynamic features, such as a plurality of air vents 2522. The vents 2522 enable air to pass through the PCB assembly 2502 to reduce wind pressure on the PCB assembly and may assist with heat dissipation. This vent configuration advantageously enables the PCB assembly to be implemented in high environments and prevents excessive wind loading. Additionally the air vents 2522 are configured for removing the heat generated by the LED modules 2504 and other electrical components. The cooling exchange provided by the vents 2522 reduces localized hot spots in the PCB assembly 2502.

As can be seen in FIGS. 27 and 28, the junctions 2505 are connected by bridges 2517 in which the air vents 2522 are defined between the bridge and junctions. The multilayer substrate includes the bridges 2517. The air vents 2522 are devoid of material between four adjacent junctions 2505 and bridges 2517. As can be seen in the FIGS. 27-29, the air vents 2522 are generally shaped as a square configuration. Nonetheless, other shapes are possible. The bridges 2517 have a width smaller than the diameter of the junctions 2505. A ratio of the width of the bridges to the diameter of the junctions is less than one. This is one way of controlling the size of the vents by controlling the width of the bridges 2517. Advantageously, this configuration reduces wind pressure on the PCB assembly 2502. In an exposed environment, the air may flow through the vents 2522 for passive cooling of the LED modules 2504 by way of natural convection.

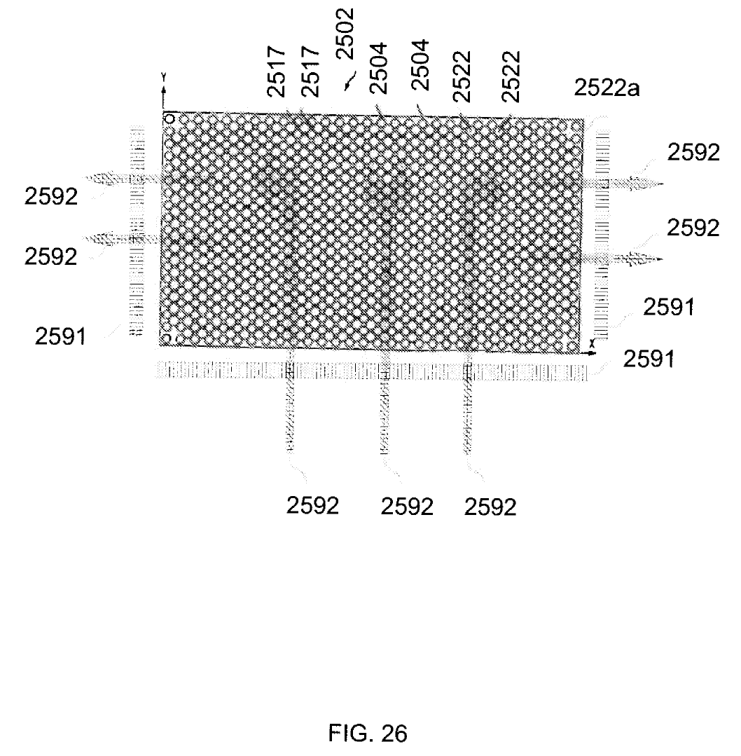

The air vents 2522 of FIGS. 25-28 can also be advantageous when EHD pumps are used for active cooling, for example for in-door applications. In FIG. 25 EHD pump 2591 generates a laminar airflow 2592 across the LED panel to remove heat from the LEDs. In FIG. 26 is shown how multiple EHD pumps 2591 can be assembled to generate a very particular air flow 2592 across the LED panel 2502 by blowing fresh, cool air into the system and by removing hot air out of the system. Such a setup can, for example, be deployed when an LED panel is mounted inside a casing and or when the LED panel operates in confined spaces. In FIG. 27 and FIG. 28 EHD pump 2591 generates a crossflow 2592 across the LED panel 2502. Even in the case when the LED panel 2502 has no vents at all, one or more EEL pump can be used to generate an airflow strong enough for sufficient heat removal. Therefore, the vents 2522 can complement the cooling effect when combined with EHD pumps, or in many other applications the airflow generated by the EHD pump can be sufficient to cool the LED panel even without the vents.

EHD pump 2591 or 2193 can be can be embodied by using any of the structures or techniques described in connection with FIGS. 1 to 8 above. According to the compact form factor aspects of the invention, in an example configuration where LED(s) in 2504 are in a 3.20 mm by 1.27 mm package, the vents are about 5 mm² in area and LEDs are spaced apart by about 10 mm, and EHD pump 2591 or 2593 operate at about 3500 volts DC.

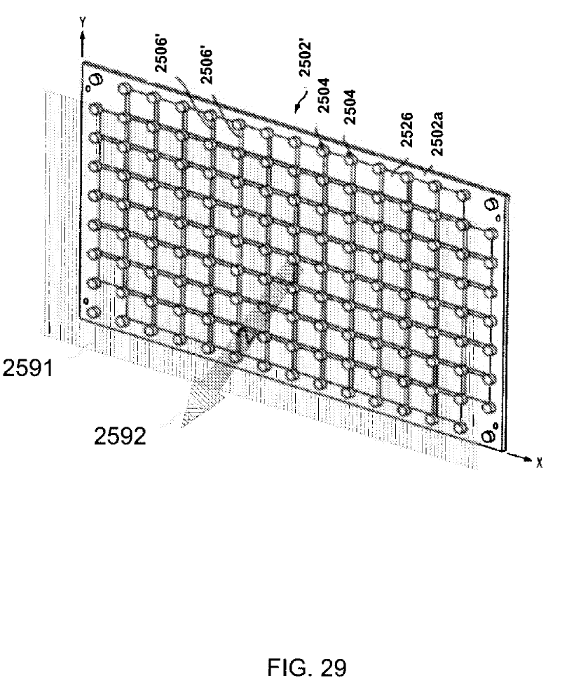

FIG. 29 shows an alternative PCB assembly 2502′ with large size vents 2526 to promote additional air passing through PCB assembly and additional cooling of the LED modules 2504. The size of the vents 2526 are controlled by the width of the bridges 2506′ and the length. This configuration enables more air to pass through the vents 2526 for reducing wind loading and subsequent stress on the structure. PCB assembly 2502′ has similar components of PCB assembly 2502. PCB assembly 2502′ may be used with other aspects of heat dissipation and aerodynamic features of the present invention. As shown in FIG. 29, the “large” size of the vents means that they are many times the size of each LED module, in contrast to the above embodiments that are less than 1:1, thus providing a minimal cross-section to wind. While a single LED is shown, the inventive aspects can be practiced with multiple LEDs or LED modules. FIG. 29 also shows an exemplary how one or more EHD pumps 2591 can be used to generate an airflow 2592 through the air vents 2526 (and, obviously through vents 2522, too). The high flexibility in form factors that EHD pumps enable, clearly demonstrate the various active cooling possibilities for active LED cooling.

### Construction

A fabrication process for constructing a micro-channel heat sink with EHD gas flow is unique by itself and is another aspect of the invention as will now be described in more detail in connection with a preferred embodiment illustrated in FIGS. 14A to 14D.

As shown in FIG. 14A, the process starts with a substrate material 1402 such as an electrically conductive wafer comprised of silicon, aluminum, doped SiC, carbon fiber or copper. Next, in FIG. 14B, a dielectric material is deposited or grown on the surface 1404 (e.g., a thermal oxide can be grown on silicon, aluminum can be anodized or a thick film photoresist can be deposited). A sheet of dielectric material can also be bonded to the substrate (e.g., a sheet of glass, quartz, borofloat or Plexiglas can be attached to the substrate). Next, in FIG. 14C, photolithography techniques can be used to pattern the first electrodes 1406 and bus 1408 on the surface of the dielectric. The final step shown in FIG. 14D is to mechanically cut the micro-channels 1410 with a diamond dicing saw or wire electrostatic discharge machine (EDM), or chemically etch away the excess material with dry and wet etching techniques. A combination of mechanical and chemical techniques can also be utilized.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

1. A cooling system, comprising:
a structure that is thermally coupled to an LED; and
an electrohydronamic (EHD) pump for creating an airflow over the structure.

2. A cooling system according to claim 1, wherein the EHD pump is adapted for a corona wind EHD technique.

3. A cooling system according to claim 1, wherein the EHD pump is adapted to operate with safety and reliability features.

4. A cooling system according to claim 3, wherein the safety and reliability features include one or more of no ozone, no sparks, no arcs, resilient to dust.

5. A cooling system according to claim 1, wherein the EHD pump has a compact form factor.

6. A cooling system according to claim 5, wherein the EHD pump has an electrode gap of less than 5 mm.

7.-31. (canceled)

32. An LED light bulb comprising:
a light-emitting diode (LED);
a heat sink thermally coupled to the LED, the heat sink comprising at least a portion of the outside body of the LED light bulb; and
an electro-hydrodynamic (EHD) air pump oriented to generate an airflow impinging on at least a portion of the surface of the heat sink.

33. The LED light bulb of claim 32, further comprising a heat spreader, wherein the heat sink is thermally coupled to the LED via the heat spreader.

34. The LED light bulb of claim 32, wherein the heat sink comprises a sealed room, the sealed room containing a heat conduction liquid.

35. The LED light bulb of claim 32, wherein the heat sink comprises a plurality of fins extending radially.

36. The LED light bulb of claim 35, wherein the fins of the heat sink form channels oriented substantially parallel to the direction of light generated by the LED light bulb.

37. The LED light bulb of claim 36, wherein at least a portion of the airflow generated by the EHD air pump impinges on the channels formed by the fins of the heat sink.

38. The LED light bulb of claim 32, wherein the EHD air pump has a substantially ring-like shape.

39. The LED light bulb of claim 38, wherein the EHD air pump has a substantially toroidal shape.

40. The LED light bulb of claim 38, wherein the EHD air pump comprises a collector electrode having a substantially ring-like shape.

41. The LED light bulb of claim 40, wherein the EHD air pump comprises an emitter electrode having a substantially ring-like shape.

42. An LED light device comprising:
a printed circuit board (PCB) having a plurality of regularly spaced air passage openings through the PCB;
a plurality of light-emitting diodes (LEDs) attached to the PCB; and
an electro-hydrodynamic (EHD) air pump oriented to generate an airflow through the air passage openings of the PCB.

43. The LED light device of claim 42, wherein the airflow generated by the EHD air pump is substantially perpendicular to the PCB.
